(19) United States
(12) Patent Application Publication
(10) Pub. No.: US 2010/0219139 A1
(43) Pub. Date: Sep. 2, 2010

(54) FLUID TREATMENT ARRANGEMENTS WITH FLUID TREATMENT ELEMENTS AND METHODS FOR MAKING AND USING THEM

(75) Inventors: Thomas Welch, Jr., Homer, NY (US); Tanweer ul Haq, Tully, NY (US); Joseph Verschneider, Cortland, NY (US)

Correspondence Address: LEYDIG VOIT & MAYER, LTD, 700 THIRTEENTH ST. NW, SUITE 300, WASHINGTON, DC, 20005-3960, US

(73) Assignee: PALL CORPORATION, Port Washington, NY (US)

(21) Appl. No.: 12/531,720

(22) PCT Filed: Mar. 14, 2008
(86) PCT No.: PCT/US08/57002

§ 371 Date: Apr. 14, 2010

Related U.S. Application Data
(60) Provisional application No. 60/907,067, filed on Mar. 19, 2007.

(51) Int. Cl. B01D 29/07; B01D 29/21; B01D 29/41; B32B 37/00; B32B 38/00

(52) U.S. Cl. 210/767; 210/457; 210/345; 210/446; 156/60; 156/191

(57) ABSTRACT

Fluid treatment arrangements and methods for making and using fluid treatment arrangements are disclosed. A ribbon including a permeable fluid treatment medium may be spirally wound in a plurality of windings to form a fluid treatment element having a disk-shaped body. The disk-shaped body may include opposite end surfaces, an inner rim, and an outer rim. Up to one hundred or more fluid treatment elements may be positioned along a core assembly, and a surround may be positioned around the fluid treatment elements. The fluid treatment elements may be sealed to the core assembly with the inner rims covering openings in the core assembly, or the fluid treatment elements may be sealed to the surround with the outer rims covering openings in the surround. A fluid treatment arrangement may be contained in a housing to form a fluid treatment assembly. The housing may include an inlet port and an outlet port and may define a fluid flow path between the inlet port and the outlet port. The fluid treatment arrangement may be positioned in the housing across the fluid flow path.

This application claims priority based on U.S. Provisional Application No. 60/907,067, which was filed on Mar. 19, 2007, and is incorporated by reference.

### DISCLOSURE OF THE INVENTION

The present invention relates to fluid treatment arrangements and methods for making and using fluid treatment arrangements. In particular, the present invention relates to fluid treatment arrangements and methods for making and using fluid treatment arrangements which include one or more spirally wound fluid treatment elements. A fluid treatment element may be fashioned by spirally winding a ribbon in a plurality of windings to form a generally disk-shaped body. The ribbon may include a long, narrow strip of a permeable fluid treatment medium having first and second opposite major surfaces and first and second opposite side edges. The disk-shaped body may have an axially-facing end surface which faces in one direction, an axially-facing end surface which faces in the opposite direction, an inner rim, and an outer rim. To form a fluid treatment arrangement, several of these fluid treatment elements may be positioned along a hollow core assembly. A single set of fluid treatment elements may be mounted along the core assembly. Alternatively, a plurality of sets of fluid treatment elements may be mounted along the core assembly. For example, one set may be radially displaced from the other set, and a surround may be positioned between adjacent sets to guide fluid flow from the fluid treatment elements of one set to the fluid treatment elements of the adjacent set.

A fluid may be directed through each fluid treatment element from both end surfaces to the inner rim or the outer rim of the fluid treatment element. For example, fluid may enter both end surfaces through the opposite side edges of the permeable fluid treatment medium of each winding and then flow within the fluid treatment element to the inner rim. For the windings closer to the inner rim, the fluid may pass to the inner rim generally edgewise through the permeable fluid treatment medium, i.e., generally laterally within the permeable medium generally parallel to the first and second opposite major surfaces. For the windings farther from the inner rim, the fluid may pass to the inner rim generally radially inwardly through successive windings of the permeable fluid treatment medium. Alternatively, fluid may enter both end surfaces through the opposite side edges of the permeable fluid treatment medium of each winding and then flow within the fluid treatment element to the outer rim. For windings closer to the outer rim, the fluid may pass to the outer rim generally edgewise through the permeable fluid treatment medium. For windings farther from the outer rim the fluid may pass to the outer rim generally radially outwardly through successive windings of the permeable fluid treatment medium.

Fluid treatment arrangements embodying one or more aspects of the invention may be used to treat fluids, including gases, liquids, or mixtures of gases, liquids, and/or solids, in a wide variety of ways. For many embodiments, the fluid treatment arrangement may be used in a separation process to separate one or more substances from the fluid. For example, the separation process may be a filtration process where a fluid is directed through the fluid treatment elements of the fluid treatment arrangement and substances in the fluid, e.g., particulates or molecules above a certain size, are prevented by the fluid treatment media from passing through the elements with the fluid. As another example, the separation process may be a capture process where a fluid is directed through the fluid treatment elements and substances in the fluid, e.g., ions, molecules, proteins, nucleic acids, or other chemical substances, are chemically or physically bound to the fluid treatment media. For other embodiments, the fluid treatment arrangement may be used in a coalescing process where a fluid is directed through the fluid treatment elements and small droplets of liquid entrained in the fluid are aggregated and enlarged as the fluid passes through the fluid treatment media, allowing larger liquid droplets to emerge from the element and to be more easily removed from the fluid.

### SUMMARY OF THE INVENTION

In accordance with one aspect of the invention, fluid treatment arrangements may comprise a hollow core assembly, a fluid treatment element, and a fluid pathway. The hollow core assembly may include an axis, an exterior, an interior, and an opening which fluidly communicates between the exterior and the interior of the core assembly. The fluid treatment element may include a ribbon having a permeable fluid treatment medium and may be spirally wound in a plurality of windings to define a generally disk-shaped body. The disk-shaped body may have a radial dimension, a first axially-facing end surface on one side of the body, a second axially-facing end surface on the opposite side of the body, and an inner rim. The fluid treatment element may be mounted along the core assembly with the inner rim covering the opening in the core assembly. The fluid pathway may extend from the first and second end surfaces through one or more windings, the inner rim, and the opening into the interior of the core assembly.

In accordance with another aspect of the invention, fluid treatment arrangements may comprise a hollow core assembly and a plurality of fluid treatment elements. The hollow core assembly may include an axis, an exterior, an interior, and a plurality of openings. The openings may be axially spaced from one another along the core assembly, and each opening may fluidly communicate between the interior and the exterior of the core assembly. Each fluid treatment element may include a ribbon which has a permeable fluid treatment medium having first and second opposite side edges. The ribbon may be spirally wound in a plurality of windings to define a disk-shaped body. The disk-shaped body may include a first axially-facing end surface, a second axially-facing end surface, and an inner rim. The first end surface may comprise a plurality of windings of the first side edge of the permeable fluid treatment medium, and the second end surface may comprise a plurality of windings of the second side edge of the permeable fluid treatment medium. The fluid treatment elements are positioned along the core assembly with spaces between the fluid treatment elements and with the inner rim of each fluid treatment element covering at least one opening in the core assembly.

In accordance with another aspect of the invention, methods for making a fluid treatment arrangement may comprise mounting a plurality of spirally wound disk-shaped fluid treatment elements along a hollow core assembly. The core assembly may have a plurality of axially separated openings fluidly communicating between the exterior and the interior of the core assembly. Mounting the fluid treatment elements along the core assembly may include positioning the fluid treatment elements along the core assembly with an inner rim of each fluid treatment element covering at least one opening in the core assembly.

In accordance with another aspect of the invention, fluid treatment arrangements may comprise a hollow core assembly, a fluid treatment element, and a surround. The hollow core assembly may include an axis, an interior, an exterior, and an opening which fluidly communicates between the interior and the exterior of the core assembly. The fluid treatment element may include a ribbon which has a permeable fluid treatment medium and is spirally wound in a plurality of windings to define a disk-shaped body. The disk-shaped body may have a radial dimension, a first axially-facing end surface on one side of the body, a second axially-facing end surface on the opposite side of the body, and an outer rim. The fluid treatment element may be mounted along the core assembly. The surround may be positioned around the fluid treatment element. The surround may include at least one opening, and the fluid treatment element may be sealed to the surround with the outer rim of the fluid treatment element covering the opening in the surround.

In accordance with another aspect of the invention, fluid treatment arrangements may include a hollow core assembly, a plurality of fluid treatment elements, and a surround. The core assembly may include an axis, an exterior, an interior and one or more openings which fluidly communicate between the interior and the exterior of the core assembly. Each fluid treatment element may include a ribbon which has at least one strip of a permeable fluid treatment medium having first and second opposite side edges. The ribbon may be spirally wound in a plurality of windings to define a disk-shaped body. The disk-shaped body may include a first axially-facing end surface, a second axially-facing end surface, and an outer rim. The first end surface may comprise a plurality of windings of the first side edge of the permeable fluid treatment medium, and the second end surface may comprise a plurality of windings of the second side edge of the permeable fluid treatment medium. The plurality of fluid treatment elements may be mounted along the core assembly with spaces between the fluid treatment elements. The surround may be positioned around the fluid treatment elements and may include a plurality of openings axially separated from one another. Each fluid treatment element may be sealed to the surround with the outer rim covering at least one opening in the surround.

In accordance with another aspect of the invention, methods for making a fluid treatment element may comprise mounting a plurality of spirally wound disk-shaped fluid treatment elements along a hollow core assembly having one or more openings which fluidly communicate between the interior and the exterior of the core assembly. The methods may further comprise mounting a surround having a plurality of axially separated openings around the fluid treatment elements with an outer rim of each fluid treatment element covering at least one opening in the surround.

In accordance with another aspect of the invention, fluid treatment elements may comprise a hollow core assembly, at least first and second sets of fluid treatment elements, and a surround. The hollow core assembly may include an axis, an exterior, an interior, and one or more openings which fluidly communicate between the exterior and the interior of the core assembly. Each fluid treatment element may include a ribbon which has a permeable fluid treatment medium and is wound in a plurality of windings to define a generally disk-shaped body. The disk-shaped body may have a radial dimension, a first end surface on one side of the body, a second end surface on the opposite side of the body, an inner rim, and an outer rim. The first and second sets of fluid treatment elements may be mounted along the core assembly, the second set of fluid treatment elements being displaced radially outwardly from the first set of fluid treatment elements. The surround may be arranged between the first and second sets of fluid treatment elements and may have a plurality of openings axially separated from one another. The fluid treatment elements of the second set may be mounted along the surround with the inner rim of each fluid treatment element covering at least one opening in the surround.

In accordance with another aspect of the invention, methods for making a fluid treatment arrangement may comprise mounting a first set of spirally wound, disk-shaped fluid treatment elements along a hollow core assembly and positioning a surround having a plurality of axially separated openings around the fluid treatment elements of the first set. The methods may further comprise mounting a second set of spirally wound, disk-shaped fluid treatment elements along the core assembly. Mounting the second set of fluid treatment elements may include positioning the fluid treatment elements of the second set along the surround with an inner rim of each fluid treatment element covering at least one opening in the surround.

In accordance with another aspect of the invention, methods for treating a fluid may comprise directing a fluid axially into opposite end surfaces of a spirally wound, disk-shaped fluid treatment element and radially out of a rim of the fluid treatment element. Directing the fluid through the fluid treatment element may include passing the fluid through one or more of a plurality of windings of a ribbon having a permeable fluid treatment medium and treating the fluid by the permeable fluid treatment medium.

Embodiments of one or more aspects of the invention have many advantages. For example, by providing at least one spirally wound, disk-shaped fluid treatment element and directing fluid axially into both end surfaces and radially out of a rim, each fluid treatment arrangement may have a significantly larger inflow surface area within the space occupied by the fluid treatment arrangement. The larger inflow surface area can enhance the performance of the fluid treatment arrangement in a variety of ways. For example, where the fluid treatment arrangement functions as a filter, contaminants may be more widely distributed over the larger inflow surface area, enhancing the dirt capacity and/or the service life of the fluid treatment arrangement.

### BRIEF DESCRIPTION OF THE DRAWINGS

FIG. 1 is a quarter sectioned view of a fluid treatment arrangement.

FIG. 2 is a front view of a fluid treatment element of FIG. 1.

FIG. 3 is an oblique view of a ribbon.

FIG. 4 is a front view of another fluid treatment element.

FIG. 5 is a front view of another fluid treatment element.

FIG. 6 is a front view of another fluid treatment element.

FIG. 7 is a quarter sectioned view of a fluid treatment assembly including the fluid treatment arrangement of FIG. 1.

FIG. 8 is a quarter sectioned view of another fluid treatment assembly.

FIG. 9 is a quarter sectioned view of another fluid treatment arrangement.

FIG. 10 is a sectioned view of a portion of another fluid treatment arrangement.

FIG. 11 is a sectioned view of a portion of another fluid treatment arrangement.

FIGS. 12A and 12B are sectioned views of portions of other fluid treatment arrangements.

### DESCRIPTION OF EMBODIMENTS

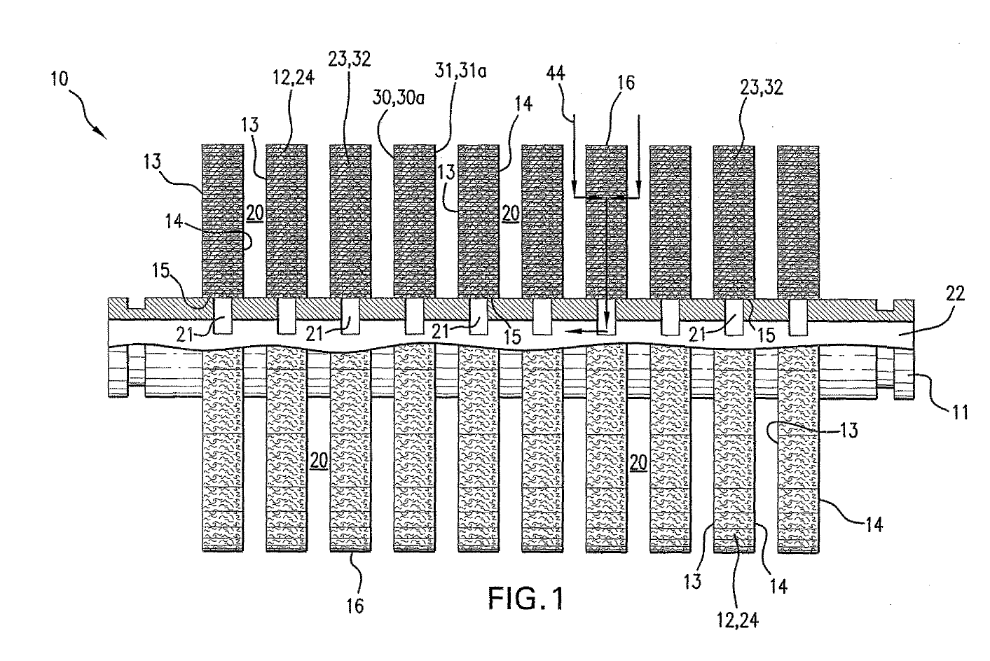

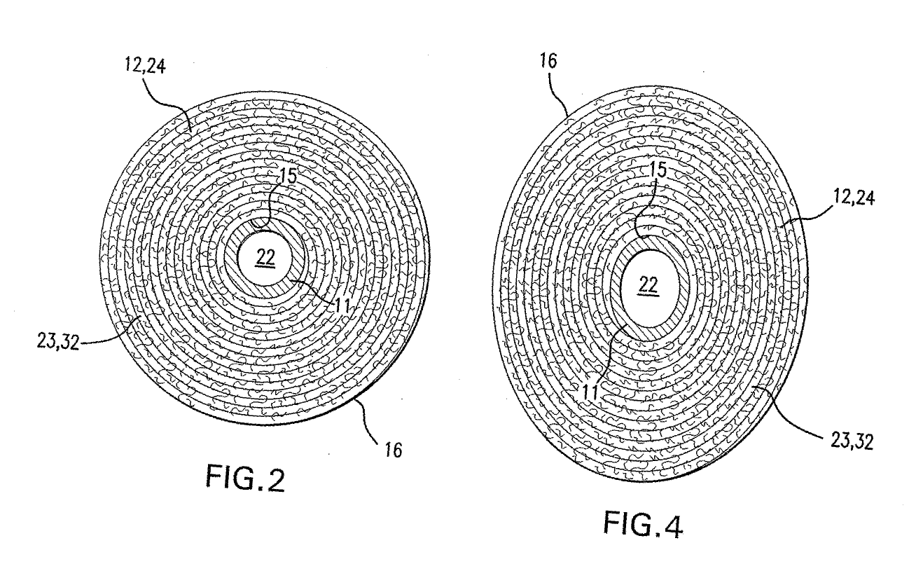

Fluid treatment arrangements embodying one or more aspects of the invention may be configured in a wide variety of ways. One example of a fluid treatment arrangement is shown in FIGS. 1 and 2, but fluid treatment arrangements are not limited to the features illustrated in either of these figures. As shown in FIGS. 1 and 2, a fluid treatment arrangement 10 may comprise a core assembly 11 and a plurality of spirally wound, disk-shaped fluid treatment elements 12 mounted along the core assembly 11, e.g., positioned circumjacent to and contacting the core assembly 11. Each disk-shaped fluid treatment element 12 may have opposite end surfaces 13, 14, an inner rim 15, and an outer rim 16. The widths and/or radial dimensions of the fluid treatment elements 12 may be similar, e.g., substantially equal, or they may vary along the core assembly 11. All of the fluid treatment elements 12 may be axially separated from one another to define spaces 20 between adjacent fluid treatment elements 12. Alternatively, some of the fluid treatment elements may be axially positioned along the core assembly side-by-side in close proximity, e.g., contacting one another, while others of the fluid treatment elements may be axially separated from adjacent fluid treatment elements to define spaces between them.

The core assembly 11 may comprise a core, such as a pipe or a tube, having an axis and a generally hollow configuration. The core assembly 11 may have two open ends or an open end and a closed or blind end. The core assembly 11 may also have a plurality of openings 21, such as slots or other perforations, which fluidly communicate between the exterior and the interior 22 of the core assembly 11. For some embodiments, openings 16 in the core assembly 11 may be axially separated from one another. The spaces 20 may be fluidly isolated from the interior 22 of the core assembly 11, for example, by a solid wall portion of the core assembly 11 which has no openings and which extends across and blocks the inner end of the space 20, and these spaces 20 may fluidly communicate with the exterior of the fluid treatment elements 12, e.g., the region radially beyond the fluid treatment elements. Spaces 20 may be located along, e.g., positioned directly next to, both end surfaces 13, 14 of each fluid treatment element 12, and the inner rim 15 of each fluid treatment element 12 may cover at least one of the openings 21 in the core assembly 11. A rim of a fluid treatment element covers an opening if the rim is located close to the opening and all fluid flowing through the opening also flows through the rim or through windings of the fluid treatment element close to the rim. For many embodiments, the inner rim 15 completely overlies an opening 21 in the core assembly 11 and may overlap the opening 21 in both axial directions.

Fluid may be directed generally inwardly between the exterior of the fluid treatment arrangement 10, e.g., the region radially beyond the fluid treatment arrangement, and the interior 22 of the core assembly 11. For example, for many embodiments, including the embodiment illustrated in FIG. 1, a feed fluid may be directed along a fluid flow path from the exterior of the fluid treatment arrangement 10 generally radially inwardly into the spaces 20 alongside the fluid treatment elements 12. From the spaces 20, the fluid may flow generally axially along the fluid flow path into each fluid treatment element 12 through both end surfaces 13, 14. For many embodiments, fluid may also flow into each fluid treatment element 12 through the outer rim 16. The fluid may flow within each fluid treatment element 12 to the inner rim 15, where the fluid flows radially out of the fluid treatment element 12 through an opening 21 in the core assembly 11 and then axially along the interior 22 of the core assembly 11.

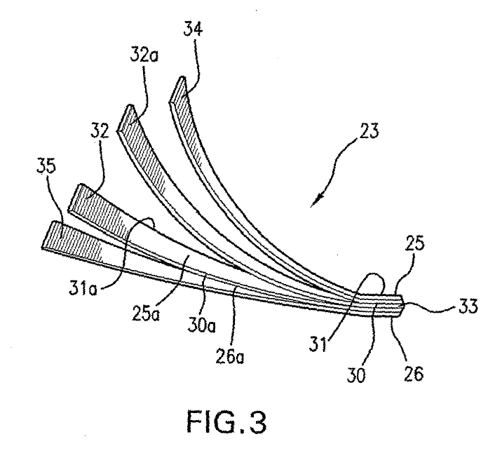

An example of a fluid treatment element 12 is shown in FIG. 2, but fluid treatment elements are not limited to the features illustrated in this figure. As shown in FIG. 2, the fluid treatment element 12 may comprise a ribbon 23 which is spirally wound in a plurality of windings to form a generally disk-shaped body 24. Ribbons may be configured in a wide variety of ways. One example of a ribbon is shown in FIG. 3, but ribbons are not limited to the features illustrated in this figure. As shown in FIG. 3, the ribbon 23 may have a long, narrow configuration with opposite major surfaces 25, 26 and opposite side edges 30, 31. The ribbon 23 includes a strip of a permeable fluid treatment medium 32 which also has opposite major surfaces 25a, 26a and opposite side edges 30a, 31a. The ribbon 23 including the porous fluid treatment medium may be permeable but unperforated, i.e., free of any through holes or through slots which extend between the opposite major surfaces 25, 26; 25a, 26a.

The permeable fluid treatment medium may be formed from any of numerous materials, including, for example, a natural or synthetic polymer, glass, metal, carbon, and/or a ceramic. The permeable fluid treatment medium may be formed from any of a variety of structures, including, for example, fibrous structures, such as woven or non-woven fibrous strips; meshes, such as woven, extruded, or expanded mesh strips; permeable membranes, such as supported or unsupported membrane strips; porous foam strips; or porous metals, such as porous sintered fiber metal or powder metal strips. The permeable fluid treatment medium may have any of a myriad of treatment characteristics. For example, the permeable fluid treatment medium may have, or may be modified to have, any of several characteristics. The permeable fluid treatment medium may have a positive, negative, or neutral electrical charge; it may be liquiphobic or liquiphilic including, for example, hydrophobic or hydrophilic, or oleophobic or oleophilic; it may include attached functional groups, such as ligands or any other reactive moiety, that can chemically bind to substances in the fluid. The permeable fluid treatment medium may be formed from, impregnated with, or otherwise contain a variety of materials that function to treat the fluid in any of various ways. These functional materials may include, for example, sorbents, ion exchange resins, chromatography media, enzymes, reactants, or catalysts, that may chemically or physically bind, react with, deliver, catalyze or otherwise affect substances in the fluid or the fluid itself. Further, the permeable fluid treatment medium may have any of a wide range of removal ratings, including, for example, from ultraporous or nanoporous or finer to microporous or coarser. For example, the removal rating may be in the submicron range or finer, e.g., up to about 0.02 μm or coarser, or up to about 0.1 μm or coarser, or may be in the micron range or coarser, e.g., up to about 1 μm or coarser, or about 5 μm or coarser, or about 10 μm or coarser, or about 50 μm or coarser, or about 75 μm or coarser, or about 100 μm or coarser, or about 200 μm or coarser, or about 300 μm or coarser, or about 500 μm or coarser, or about 1000 μm or coarser. For many embodiments, the permeable fluid treatment medium may comprise a filter medium of non-woven glass or polymeric fibers, and the fluid treatment characteristic of the permeable fluid treatment medium may comprise a removal rating of about 0.02 μm or coarser.

The ribbon, including the strip of permeable fluid treatment medium may have a variety of lengths, thicknesses, and widths. For many embodiments, the ribbon may be continuous and extend the full length required to provide a sufficient number of windings to form a fluid treatment element having any desired radial dimension. For other embodiments, shorter segments of the ribbon may be connected end-to-end to extend the full length. Further, for many embodiments, the ribbon may be generally straight along the length of the strip. However, the ribbon may be curved. For example, the ribbon may have a cyclical, e.g., sinusoidal or sawtooth, pattern which extends along the length of the strip.

The thickness of the ribbon, including the strip of permeable fluid treatment medium, i.e., the distance through the ribbon from one major surface to the opposite major surface, may vary, depending, for example, on the structure of the permeable fluid treatment medium. The thickness may be in the range from about two thousandths of an inch or less, for example, for a thin permeable polymeric membrane, to about 250 thousandths of an inch or more, for example, for a lofty fibrous material or a porous foam. Although the thickness may be nonuniform along the length of a ribbon, for many embodiments the thickness is uniform along the length of the ribbon.

The width of the ribbon, including the strip of permeable fluid treatment medium, i.e., the distance through the ribbon from one side edge to the opposite side edge, may also vary. For many embodiments, the width may be in the range from about one-sixteenth of an inch or less to about 1 inch or 2 inches or 3 inches or more. For example, the width may be in the range from about 2 inches or less, e.g., 1 inch or less, to about one-sixteenth inch or more, including the range from about one-eighth inch or more to about one-half inch or less. Further, the width may be uniform along the length of the ribbon, or the width of the ribbon may be nonuniform along the length of the ribbon. For example, the width of the ribbon may vary along the length over a longer distance, e.g., providing a fluid treatment element which tapers to a narrow rim or flares to a wide rim, for example. The width of the ribbon may also vary over a shorter distance, e.g., providing a ribbon with one or two pinked edges. One or both edges may also be fringed or frizzed. Fluid treatment elements which include ribbons having pinked, fringed or frizzed edges are disclosed, for example, in U.S. Provisional Application No. 60/907,065 entitled Fluid Treatment Elements and Fluid Treatment Arrangements with Fluid Treatment Elements Having Uneven Surfaces and Methods for Making and Using Them, which listed Thomas Welch, Jr., Stephen Geibel, and Tanweer ul Haq as an inventor and which was filed on Mar. 19, 2007, and the PCT International application which claims priority based on this Provisional application, both of which are incorporated by reference to support these and other features.

The ribbon 23 may include the strip of permeable fluid treatment medium 32 as the sole component of the ribbon, and the major surfaces of the fluid treatment medium may be in contact along adjacent windings. Alternatively, the ribbon may include multiple components. For example, the ribbon may include the permeable fluid treatment medium as one layer of a multilayer composite 33 with two or more layers superposed on one another, as shown in FIG. 3. Various additional layers may be included, such as additional layers of permeable fluid treatment media 32a. The fluid treatment media 32, 32a may be identical to, or different from, one another. For example, the permeable fluid treatment medium layers 32, 32a may have the same or different fluid treatment characteristics. Another additional layer may be a strengthening strip 34 that enhances the structural integrity of the ribbon. The ribbon may be in tension as it is wound in multiple windings to form the fluid treatment element, and the permeable fluid treatment medium may not have sufficient strength to withstand the tension. Consequently, a strengthening strip 34 that can better withstand the tension, such as a strip of a polymeric film, may be layered with the fluid treatment medium. Another additional layer may be a bonding strip 35 for bonding adjacent surfaces of adjacent windings of the ribbon. All of the fluid treatment medium layers may be permeable. All other layers of the composite may also be permeable or may otherwise be structured to allow fluid to flow through the windings of the ribbon normal to the major surfaces of the ribbon. Further, while the multiple layers of the composite ribbon may not all have of the same width or be in register, for many embodiments, the multiple layers all have substantially the same width and the side edges are in register, as shown in FIG. 3. The ends of the layers may be in register or may be staggered. For many embodiments, the thickness of the additional layers, other than any additional fluid treatment medium layers, may be less than the thickness of the fluid treatment medium layers to increase the relative volume of the fluid treatment medium within the fluid treatment element.

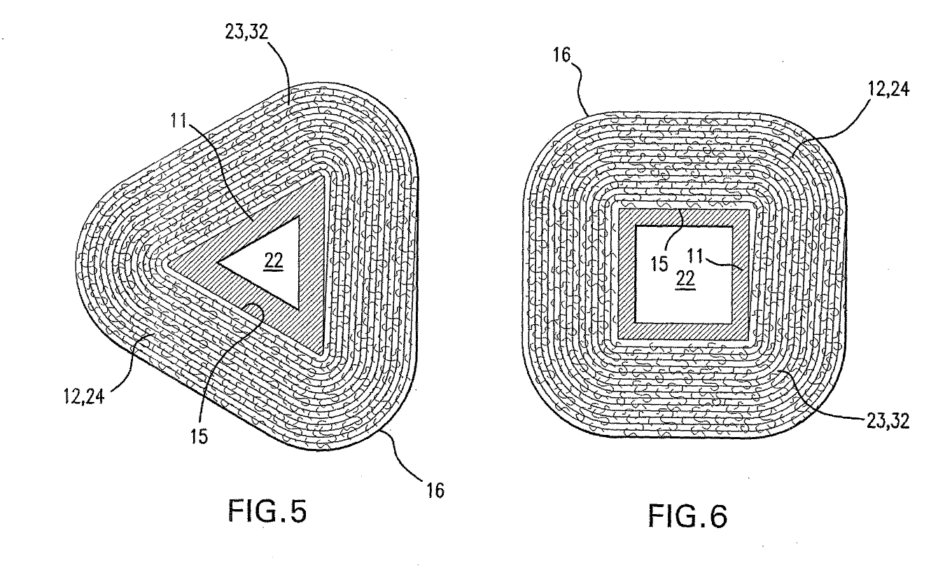

A fluid treatment element 12 formed by spirally winding the ribbon 23 in a plurality of windings may have any of numerous irregular or regular geometrical forms. For example, the spirally wound disk-shaped body 24, of the fluid treatment element 12 as well as the core assembly 11, may have a generally circular form, as shown in FIG. 2, or a generally oval, triangular, or rectangular form, as shown in FIGS. 4, 5, and 6, respectively. The radial dimension of a fluid treatment element 12, i.e., the dimension generally perpendicular to the axis of the core assembly 11, for example, from the innermost winding to the outermost winding, may vary, depending, for example, on the number of windings and the thickness of the ribbon. For example, the radial dimension may be in the range from about ¼ inch or less or about ⅛ inch or less to up to about 1 inch or up to about 2 inches or up to about 6 inches or up to about 10 inches or up to about 25 inches or more. The aspect ratio, i.e., the ratio of the radial dimension of the fluid treatment element to the width of the ribbon, may also vary. For some embodiments, the aspect ratio may be greater than about 10. For many embodiments, the aspect ratio may be about 10 or less, or about 5 or less, or about 4 or less, or about 3 or less, or about 2 or less, or about 1 or less. The volume of a fluid treatment element 12 may also vary, for example, in accordance with the width of a ribbon and the radial dimension of the disk-shaped body. For some embodiments, all of the fluid treatment elements of a fluid treatment arrangement may have the same volume. For some embodiments, the fluid treatment elements may have different volumes.

As shown in FIG. 1, each disk-shaped body 24 may have an end surface 13 which faces in one axial direction, an end surface 14 which faces in the opposite axial direction, an inner rim 15 along the interior of the fluid treatment element 12, an outer rim 16 along the exterior of the fluid treatment element 12, and a radial dimension, e.g., from the initial winding near the core assembly to the outer rim 16. One end surface 13 may comprise the plurality of windings of one side edge 30 of the ribbon 23, including one side edge 30a of the permeable fluid treatment medium strip 32. The other end surface 14 may comprise the plurality of windings of the other side edge 31 of the ribbon 23, including the other side edge 31a of the permeable fluid treatment medium strip 32. Either or both end surfaces may be an even surface or may be an uneven surface, for example, as disclosed in the previously referenced U.S. Provisional Application No. 60/907,065 entitled Fluid Treatment Elements and Fluid Treatment Arrangements with Fluid Treatment Elements Having Uneven Surfaces and Methods for Making and Using Them and the PCT International application which claims priority based on this Provisional application. Within the fluid treatment elements 12, a fluid pathway 44 may extend generally axially into each end surface 13, 14 through the side edges 30, 31; 30a, 31a of the ribbon 23 including the permeable fluid treatment medium 32 and may further extend generally radially inwardly through successive windings of the ribbon 23 including the permeable fluid treatment medium 32 and out of the inner rim 15. Consequently, both end surfaces 13, 14 of the fluid treatment elements may comprise feed or inflow surfaces.

Many, most, or substantially all of the fluid treatment elements 12 may be positioned along the core assembly 11 axially separated from one another. Adjacent fluid treatment elements 12 may be structurally separate from one another within the spaces 20 between them. Further, facing end surfaces 13, 14 of adjacent fluid treatment elements 12 may be spaced from one another with few or no points of contact between them. In addition, one or both end surfaces 13, 14 of each fluid treatment element 12 may immediately face and open directly onto a space 20, and each space 20 may be bounded by the end surfaces 13, 14 of adjacent fluid treatment elements 12. For many embodiments, end surfaces 13, 14 of adjacent fluid treatment elements 12 may face one another and define the space 20 between them. In the embodiment shown in FIG. 1, the spaces 20 may be fluidly isolated from the interior 22 of the core assembly 11 by a solid wall portion of the core assembly 11 which does not have any openings, and many, most, or substantially all of the spaces 20 may be feed spaces. The distance between adjacent fluid treatment elements 12 may define the width of each space 20 and the widths of the spaces 20 may be uniform or non-uniform. The spaces 20 may extend between adjacent fluid treatment elements 12 along at least about 85%, or at least about 90%, or at least about 95%, or about 100% of the radial dimension of the fluid treatment elements 12. For example, the spaces 20 may extend at least about 85%, or at least about 90%, or at least about 95%, or about 100% of the distance from the core assembly 11 to the outer rims 16 at the exterior of the elements 12. Further, one or more of the spaces 20 may be substantially free of structure, for example, as disclosed in U.S. Provisional Application No. 60/907,068 entitled Fluid Treatment Elements and Fluid Treatment Arrangements with Spaces Between Fluid Treatment Elements and Methods for Making and Using Them which listed Thomas Welch, Jr., Tanweer ul Haq, and Joseph Verschneider as an inventor and which was filed on Mar. 19, 2007, and the PCT International application which claims priority based on this Provisional application, both of which are incorporated by reference to support these and other features. Alternatively, the spaces may include, e.g., may be occupied by, various structures, including spacers and/or supports, for example, as disclosed in U.S. Provisional Application No. 60/907,078 entitled Fluid Treatment Elements and Fluid Treatment Arrangements with Posts and/or Bands Between Fluid Treatment Elements and Methods for Making and Using Them, which listed Thomas Welch, Jr., Tanweer ul Haq, and Joseph Verschneider as an inventor and which was filed on Mar. 19, 2007, and the PCT International application which claims priority based on this International application, both of which are incorporated by reference to support these and other features. The spaces may also include, e.g., may be occupied by, functional material, for example, as disclosed in U.S. Provisional Application No. 60/907,069 entitled Fluid Treatment Elements and Fluid Treatment Arrangements with Fluid Treatment Elements Having Different Fluid Treatment Characteristics and Methods for Making and Using Them, which listed Thomas Welch, Jr., Mark Hurwitz, Tanweer ul Haq, and Joseph Verschneider as an inventor and which was filed on Mar. 19, 2007, and the PCT International application which claims priority based on this Provisional application, both of which are incorporated by reference to support these and other features.

Fluid treatment arrangements may be made in any of several different ways. According to one general example, methods for making a fluid treatment arrangement may comprise positioning a plurality of spirally wound, disk-shaped, fluid treatment elements along a hollow core assembly having a plurality of axially separated openings which fluidly communicate between the exterior and the interior of the core assembly. Mounting the fluid treatment elements along the core assembly includes positioning the fluid treatment elements along the core assembly with an inner rim of each fluid treatment element covering at least one opening in the core assembly.

The fluid treatment elements may be mounted along the core assembly in a variety of ways. For example, at least one and as many as at least 10 or more, or at least 25 or more, or at least 50 or more or at least 100 or more ribbons may be spirally wound in a plurality of windings around the core assembly to form fluid treatment elements at different axial locations along the core assembly corresponding to the openings in the core assembly. All of the fluid treatment elements may be separated by spaces, or some of the fluid treatment elements may be in contact side-by-side while other fluid treatment elements may be spaced from adjacent fluid treatment elements. All of the fluid treatment elements may have identical or similar treatment characteristics. Alternatively, the fluid treatment elements may have different treatment characteristics, for example, as disclosed in the previously referenced U.S. Provisional Application No. 60/907,069 entitled Fluid Treatment Elements and Fluid Treatment Arrangements with Fluid Treatment Elements Having Different Fluid Treatment Characteristics and Methods for Making and Using Them and the PCT International application which claims priority based on this Provisional application.

The ribbons may be wound around the core assembly one at a time, several at a time, or all at the same time, e.g. either sequentially or simultaneously. The inner end region of each ribbon 23, e.g., the region defining the first winding, may be wound directly onto the core assembly 11 covering at least one opening 21 in the core assembly 11. The width of the opening may be less than the width of the end region of the ribbon. For many embodiments, the ribbon, including the permeable fluid treatment medium, completely overlies or underlies the opening and may overlap the opening in both axially directions. For example, the opening may be centered on the ribbon and the width of the opening may be less than about 85% but greater than about 10% of the width of the ribbon. The inner end region of the ribbon may be sufficiently sealed against the core assembly to secure the ribbon in place on the core assembly and to prevent fluid flow into the opening except via the inner rim of the fluid treatment element. For example, a portion of the inner end region may be fixed to the core assembly by heat bonding, adhesive bonding, or solvent bonding without blinding the opening in the core assembly. Alternatively, the inner end region may not be bonded to the core assembly but may, for example, be compressively fit against the core assembly by tightly winding the initial windings around the core assembly over the opening. Further, the inner end region may have a tapered thickness or may be sufficiently tightly wound that no step is formed at the transition between the end of the first winding and the beginning of the second winding.

Each ribbon may be spirally wound in a plurality of windings under tension to form a fluid treatment element of any desired radial dimension. The tension may be constant or may vary with increasing radius of the fluid treatment element, and the tension may be empirically selected based on many factors. For example, a maximum tension at which the ribbon detrimentally elongates, e.g., the tension at which the fluid treatment medium unduely stretches or begins pulling apart, may be determined. The ribbon may then be spirally wound using a tension less than the maximum tension, for example, no greater than about 80% or no greater than about 65% or no greater than about 50% of this maximum tension. Further, the ribbon may be spirally wound using a tension which provides similar compression, e.g., substantially uniform compression, of the fluid treatment medium from one winding to the next along most or all of the radial dimension of the fluid treatment element. By providing similar compression from one winding to the next, the fluid treatment element may more evenly treat the fluid flowing through the plurality of windings of the fluid treatment medium. For example, if the fluid treatment medium comprises a filter medium, the fluid treatment element may be more uniformly loaded along the radial dimension of the element, increasing the dirt capacity and/or the service life of the element. The ribbon may also be wound with sufficient tension to form a substantially self-supporting fluid treatment element having a stable, firm disk-shaped body. For example, the ribbon may be wound with sufficient tension to hold adjacent windings and adjacent layers against each other tightly enough to prevent lateral slippage and/or radial separation of the adjacent windings and adjacent layers at the differential pressures that may be encountered by the fluid treatment element.

After each ribbon has been spirally wound to a desired radial dimension, the outer end region of the ribbon may be held in place in any of numerous ways. For example, the outer end region may be bonded to the adjacent winding for example, by heat bonding, adhesive bonding, or solvent bonding. Alternatively or additionally, the outer end region of the ribbon may be staked to other windings. For example, a heat stake in the form of a weld bead or a bead of a settable bond material such as a hot-melt adhesive, a polyurethane, or an epoxy, may be drawn along one or both side edges of the outer end region of the ribbon and the outer windings.

The stability of a spirally wound fluid treatment element may be further enhanced by staking much or all of the disk-shaped body. For example, generally radially extending stakes may be applied along one or both end surfaces of the fluid treatment element and/or at various angularly-spaced positions around each surface. Each stake may extend mostly or completely along the fluid treatment element, e.g., to the core assembly, fixing the fluid treatment element to the core assembly. For most embodiments, the stakes may be applied along one or both end surfaces of the fluid treatment element. However, for some embodiments, the stakes may be applied internally within the fluid treatment element. For example, a heated pin may be inserted and withdrawn through the windings, or a settable bonding material may be injected into the fluid treatment element by inserted and withdrawing a hollow needle.

The fluid treatment elements may be mounted along the core assembly with spaces between many, most, or substantially all of the elements. Before, while, or after the fluid treatment elements are mounted along the core assembly, structures may be inserted in some of the spaces between the elements. For example, some of the spaces may be occupied by spacers and/or supports or functional material. Alternatively, many, most, or substantially all of the spaces may remain substantially free of structure.

After the fluid treatment arrangements are formed, they may be contained within a wide variety of housings to provide fluid treatment assemblies. The fluid treatment assembly may comprise a housing containing only a single fluid treatment arrangement or a housing containing multiple fluid treatment arrangements arranged serially or in parallel within the housing. For example, the housing may include one or more tube sheets and multiple fluid treatment arrangements may be associated with the tube sheets. The housing may permanently contain the fluid treatment arrangement, e.g., forming a disposable fluid treatment assembly, or the housing may removably contain the fluid treatment arrangement, allowing a used fluid treatment arrangement to be replaced by a new fluid treatment arrangement in a reusable housing.

The housing may be formed from any impermeable material, e.g., a metallic material or a polymeric material, which is compatible with the process parameters, e.g., the pressure and temperature and chemical composition of the fluid. The housing may have two or more principle ports, e.g., a process or feed fluid inlet port and a filtrate or permeate outlet port. The housing may define a fluid flow path between the ports, and the fluid treatment arrangement may be positioned in the housing in the fluid flow path. The ports may be situated on the housing in any of numerous configurations, including an in-line configuration, a T-type configuration, or an L-type configuration, and the ports may comprise any of a wide variety of fittings. The housing may further include additional ports, including, for example, a retentate or concentrate outlet port and one or more ports associated with draining, venting, or cleaning, e.g., backwashing.

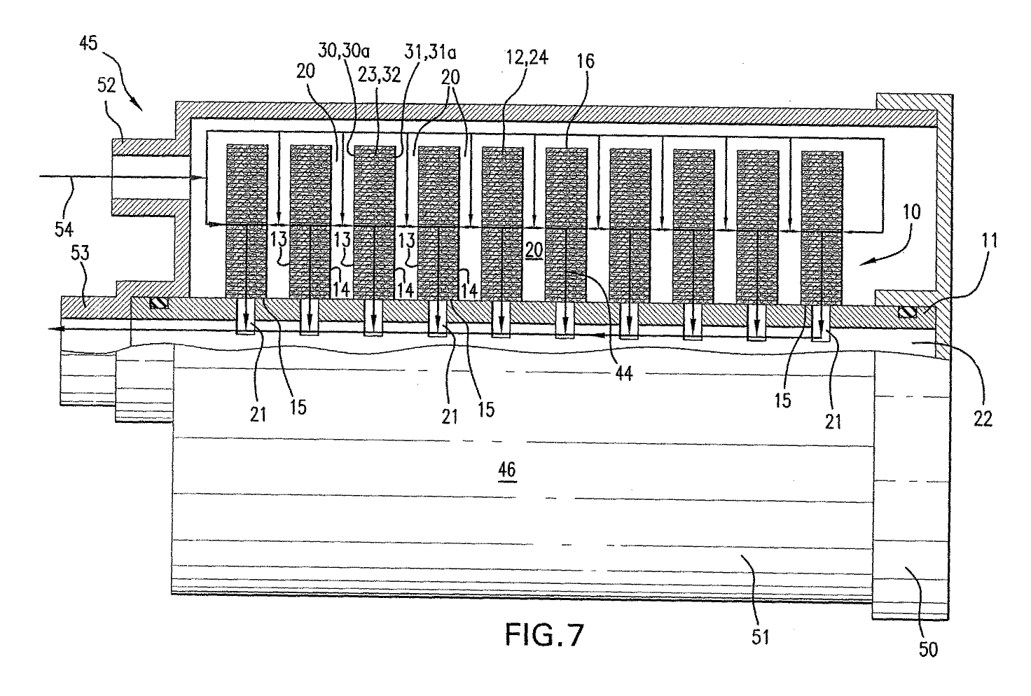

One of many examples of a fluid treatment assembly 45 and a housing 46 containing at least one fluid treatment arrangement 10 is shown in FIG. 7, but fluid treatment assemblies and housings are not limited to the features illustrated in FIG. 7. The housing 46 may include a cover 50 and a shell 51. The cover 50 may be permanently or removably mounted to the shell 51 at one end of the shell 51. The other end of the shell 51 may have a feed inlet port 52 and a permeate outlet port 53. The illustrated embodiment of the fluid treatment assembly 45 has only two ports 52, 53 and they are located on one end of the housing 46. The feed inlet port 52 may be off center fluidly communicating with the exterior of the fluid treatment arrangement 10, and the permeate outlet port 53 may be centrally located fluidly communicating with the interior 22 of the core assembly 11. Other embodiments may include more than two ports and the ports may be located anywhere along the housing, e.g., at both ends and/or in the side of the housing. The fluid treatment arrangement 10 may be sealed within the housing 46 across a fluid flow path 54 between the feed inlet port 52 and the permeate outlet port 53 with the shell 51 surrounding the fluid treatment elements 12. For example, one end of the hollow core assembly 11 may be blindly sealed against the cover 50. The opposite end of the hollow core assembly 11 may be open and sealed to the shell 51 at the permeate outlet port 53, allowing fluid communication between the interior 22 of the core assembly 11 and the permeate outlet port 53. For many embodiments, none of the fluid treatment elements 12 may be sealed to the housing 46. For example, only the core assembly 11 may be sealed to the housing 46, minimizing seals and providing a highly reliable fluid treatment assembly.

Fluid may be treated in any of numerous ways by fluid treatment assemblies, arrangements, and elements embodying the invention. One example of a method for treating the fluid may comprise directing a fluid axially into opposite end surfaces of a spirally wound, disk-shaped fluid treatment element and radially out of a rim of the fluid treatment element. Directing the fluid through the fluid treatment element may include passing the fluid through one or more of a plurality of windings of a ribbon having a permeable fluid treatment medium and treating the fluid by the permeable fluid treatment medium.

In one mode of operation, a feed fluid may be directed from the exterior of a fluid treatment arrangement to the interior of a core assembly. For example, the fluid may pass generally axially edgewise into the windings of the side edges 30, 31; 30a, 31a of the ribbon 23 including the permeable fluid treatment medium 32 comprising the end surfaces 13, 14 of each fluid treatment element 12. The fluid may also pass generally radially into the outer rim 16 of each fluid treatment element 12. The fluid may then pass generally radially inwardly within each fluid treatment element 12 through successive windings of the ribbon 23 including the permeable fluid treatment medium 32 to the inner rim 15. As the fluid flows within each fluid treatment element 12, the fluid is treated in accordance with the one or more fluid treatment characteristics of the fluid treatment medium 32. Treated fluid exits each fluid treatment element 12 via the inner rim 15 and passes radially through each opening 21 in the core assembly 11 covered by the inner rim 15 into the interior 22 of the core assembly 11.

In the embodiment illustrated in FIG. 7, the feed fluid may enter the housing 46 through the feed inlet port 52 and follow the fluid flow path 54 to the permeate outlet port 53. From the feed inlet port 52, the feed fluid may flow generally axially along the housing 46 between the exterior of the fluid treatment elements 12 and the interior of the shell 51. The feed fluid then flows generally radially inwardly into the feed spaces 20 between the end surfaces 13, 14 of the fluid treatment elements 12. From the feed spaces 20, the feed fluid may enter the fluid treatment elements 12 by flowing generally axially into the end surfaces 13, 14 of the fluid treatment elements 12, for example, via the side edges 30, 31; 30a, 31a of the ribbon 23 including the permeable fluid treatment medium 32. The feed fluid may also enter the fluid treatment elements 12 by flowing generally radially inwardly into the outer rims 16. Inside each fluid treatment element 12 the fluid may pass along the fluid flow path 54 via the fluid pathway 44 to the inner rim 15. For windings closer to the inner rim 15, the fluid may flow generally axially edgewise through the ribbon 23 including the fluid treatment medium 32 toward the inner rim 15. For windings farther from the inner rim 15, the fluid may flow generally radially inwardly normal to the major surfaces 25, 26; 25a, 26a of the ribbon 23 including the permeable fluid treatment medium 32 through successive windings toward the inner rim. As the fluid flows within the fluid treatment elements 12, the fluid may be treated in any of numerous ways, depending on the fluid treatment characteristics of the fluid treatment media. The treated fluid exits the fluid treatment elements 12 via the inner rims 15, flows generally radially through the openings 21 in the core assembly 11, and then passes generally axially along the interior 22 of the core assembly 11 to and through the permeate outlet port 53 of the housing 46.

Many advantages are associated with fluid treatment assemblies, arrangements, elements, and methods embodying one or more aspects of the invention. For example, by providing spirally wound disk-shaped fluid treatment elements and directing fluid axially into both end surfaces and radially out of a rim of the fluid treatment elements, each fluid treatment arrangement may have a significantly larger feed or inflow surface area within the space envelope occupied by the fluid treatment arrangement. The larger inflow surface area can substantially enhance the performance of the fluid treatment arrangement in a variety of ways. For example, where the fluid treatment arrangement functions as a filter, contaminants may be more widely distributed over the larger inflow surface area, enhancing dirt capacity and/or the service life of the fluid treatment arrangement.

In addition, spirally winding separate ribbons to separately form each of the plurality of fluid treatment elements facilitates manufacturing different configurations of fluid treatment arrangements and elements. The radial dimension of each element may be easily varied by winding more or less of the ribbon around the core assembly; the number of fluid treatment elements provided along the core assembly can be easily varied by winding more or fewer ribbons around the core assembly; and the location of the fluid treatment elements along the core assembly can be easily varied by simply adjusting the spacing between the ribbons being wound around the core assembly. Further, the ribbons may be spirally wound around the core assembly very quickly, speeding manufacture. Using a plurality of separate, narrow ribbons instead of, for example, a single, wide sheet with slots or other through holes in the sheet may then significantly enhance the flexibility and efficiency of manufacture, allowing fluid treatment arrangements with various numbers and sizes of elements and spacings between elements to be made without having to change out sheets of different widths or different through hole configurations. In addition, if a defect such as a hole or tear in the permeable fluid treatment medium occurs during manufacture, only the defective ribbon may be replaced rather than an entire sheet, allowing for faster and more efficient production.

In the embodiment of FIGS. 1 and 7, fluid may be directed from the exterior of the fluid treatment arrangement 10 to the interior 22 of the core assembly 11. However, fluid may also be directed from the interior 22 of the core assembly 11 to the exterior of the fluid treatment arrangement 10. For example, feed fluid may be directed through the central port 53 in the housing 46 into the interior 22 of the core assembly 11, through the openings 21 in the core assembly 11, and into the fluid treatment elements 12, where the fluid is treated. The treated fluid then flows out of the end surfaces 13, 14 of the fluid treatment elements 12, through the spaces 20 to the exterior of fluid treatment arrangement 10, and out of the housing 46 via the off center port 52. Alternatively, the fluid treatment arrangement may be differently embodied for fluid flow from the interior of the core assembly to the exterior of the fluid treatment arrangement.

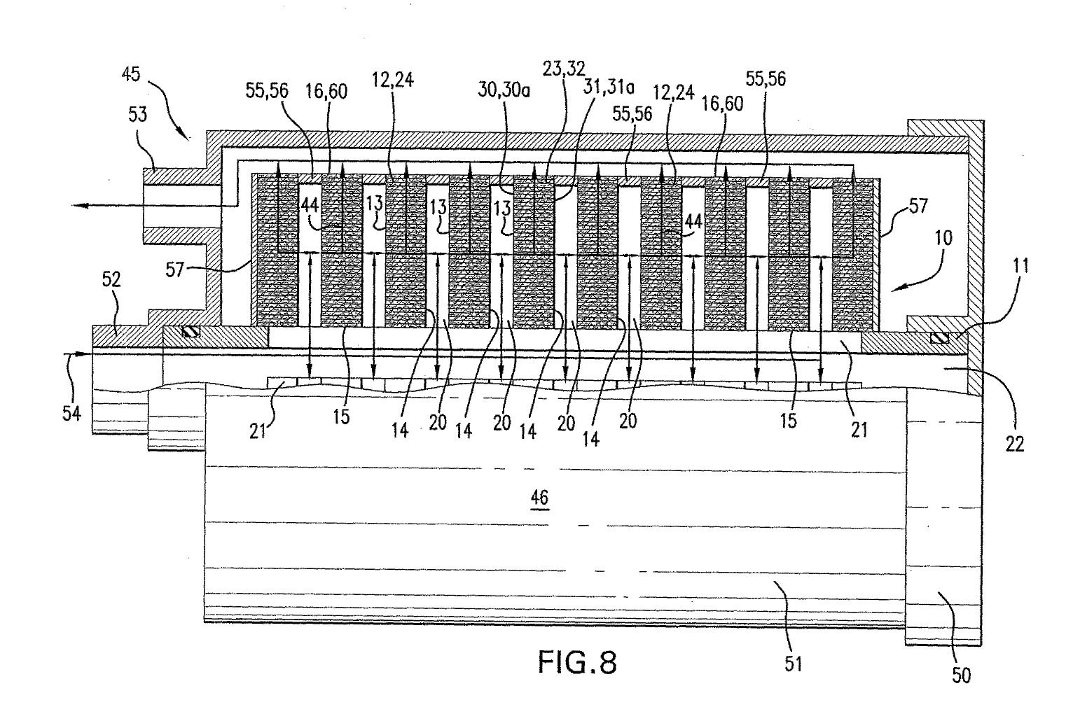

One example of a differently embodied fluid treatment arrangement 10 is shown in FIG. 8. The fluid treatment arrangement 10 may be disposed in a housing 46 to form a fluid treatment assembly 45, and the housing 46 may be substantially identical to the housing 46 shown in FIG. 7. However, the housing 46 may have a feed inlet port 52 centrally located and fluidly communicating with the interior 22 of the core assembly 11 and a permeate outlet port 53 off center and fluidly communicating with the exterior of the fluid treatment arrangement 10.

The fluid treatment arrangement 10 shown in FIG. 8 may be very similar to the fluid treatment arrangement 10 shown in FIGS. 1 and 7. The fluid treatment arrangement 10 shown in FIG. 8 includes a core assembly 11 and a plurality of fluid treatment elements 12 mounted along the core assembly 11. The filter elements 12 may be identical to the filter elements 12 of the embodiment shown in FIGS. 1 and 7. Each fluid treatment element 12 may comprise a ribbon 23 which includes a strip of fluid treatment medium 32 and is spirally wound to form a disk-shaped body 24. The core assembly 11 may include an interior 22 and an exterior. The core assembly may also include a plurality of axially separated openings, and the fluid treatment elements may be positioned between, rather than over, the openings. However, in the fluid treatment arrangement 10 shown in FIG. 8 the core assembly 11 may include one or more openings, e.g., four long, narrow, circumferentially-spaced openings 21, which extend axially along the core assembly 11 and fluidly communicate between the interior 22 and the exterior of the core assembly 11. The fluid treatment elements 12 may be mounted along the core assembly 11 with spaces 20 between adjacent fluid treatment elements 12 and the spaces 20 may be substantially free of structure or may include various structures as previously described. The openings 21 in the core assembly 11 may span all of the spaces 20 and the inner rims 15 of the fluid treatment elements 12, terminating under the endmost inner rims 15. The outwardly facing end surface 13, 14 of each endmost fluid treatment element 12 may be sealed to ensure that the fluid which passes through the endmost fluid treatment elements 12 exits the elements 12 through the outer rims 16. For example, a seal 57 such as a sealing disk or plate may be bonded to each outwardly facing end surface 13, 14 of the endmost fluid treatment elements 12. Alternatively, a settable bonding material may be applied to the outwardly facing end surfaces to seal them.

In addition to the core assembly 11 and the fluid treatment elements 12, the fluid treatment arrangement 10 may further include a surround 55 to guide fluid through the fluid treatment elements 12. The surround may be configured in a wide variety of ways, including, for example, as a component separate from but associated with the fluid treatment elements. For example, the surround 55 may comprise a plurality of separate impermeable bands 56 axially separated from one another to define a plurality of axially separated openings 60 between the bands 56. The bands 56 may encircle the outer ends of the spaces 20, bridging each space 20 between adjacent fluid treatment elements 12 and fluidly isolating the spaces 20 from the exterior of the fluid treatment arrangement 10. The fluid treatment elements 12 may be sealed to the bands 56 of the surround 55 with the outer rims 16 of the fluid treatment elements 12 covering the openings 60 between the bands 56 of the surround 55. The width of the openings 60 may be about equal to or less than the width of the outer rims 16. The bands 56 may be variously structured. For example, each band may comprise a solidified settable bonding material, including, for example, a hot-melt adhesive, a polyurethane, or an epoxy, as disclosed in the previously referenced U.S. Provisional Application No. 60/907,078 entitled Fluid Treatment Elements and Fluid Treatment Arrangements with Posts and/or Bands Between Fluid Treatment Elements and Methods for Making and Using Them and the PCT International application which claims priority based on this Provisional application. The solidified settable bonding material may be bonded to adjacent fluid treatment elements 12, for example, along outer windings of the adjacent end surfaces 13, 14 and/or along edge portions of the adjacent outer rims 16. Alternatively, the bands 56 may comprise impermeable strips, e.g., impermeable polymeric strips, bonded along edge portions of the adjacent outer rims 16. A large portion of each outer rim 16 may nonetheless remain exposed to accommodate fluid flow from the fluid treatment element 12.

Alternatively, the surround may have any configuration that fluidly blocks the ends of the spaces circumjacent to the surround while allowing fluid flow from the rims. For example, the surround may comprise a flexible polymeric sleeve that encircles all of the spaces and fluid treatment elements. The sleeve may comprise axially separated impermeable band regions which alternate with axially separated perforate band regions that have a plurality of circumferentially separated openings. The impermeable band regions may fluidly block the outer ends of the spaces. The perforate band regions may overlie the outer rims of the fluid treatment elements with the outer rims covering the openings in the perforate band regions.

Fluid treatment arrangements which include a surround may be made in any of several different ways. According to one general example, methods for making a fluid treatment arrangement may comprise mounting a plurality of spirally wound disk-shaped fluid treatment elements along a hollow core assembly having one or more openings which fluidly communicate between the interior and the exterior of the core assembly. The methods may further comprise mounting a surround having a plurality of axially separated openings around the plurality of fluid treatment elements with an outer rim of each fluid treatment element covering at least one opening in the surround.

The fluid treatment elements may be mounted along the core assembly in a variety of ways similar to those previously disclosed with respect to the embodiment shown in FIGS. 1 and 7. For example, each of several ribbons 23 which include a permeable fluid treatment medium 32 may be spirally wound in a plurality of windings around the core assembly 11 to form a disk-shaped body 24 having an end surface 13 which faces in one axial direction, an end surface 14 which faces in the opposite axial direction, an inner rim 15, and an outer rim 16. The ribbons 23 may be spirally wound around the core assembly 11 at different axial locations, e.g., locations that provide a space 20 between each adjacent pair of fluid treatment elements 12. The inner end region of each ribbon 23 may be wound directly onto and sealed to the core assembly 11 over the openings 21 in the core assembly 11, and each opening 21 may axially span several inner rims 15 and adjacent spaces 20.

The surround may be mounted to the fluid treatment elements in any of several ways. For example, a liquid settable bonding material may be applied to the outer end of each space between adjacent fluid treatment elements and then solidified, bonding the solidified settable bonding material to the fluid treatment elements and leaving much of the outer rims exposed in the openings between the solidified settable bonding material. Alternatively, a thin impermeable strip may be wrapped around the outer end of each space between adjacent fluid treatment elements, overlapping edge regions of the outer rims but leaving much of the outer rims exposed in the openings between the strips. The strip may then be bonded, e.g., adhesively bonded, solvent bonded, or heat bonded, to the outer rims. Alternatively, a sleeve may be axially slid along the outer rims of the fluid treatment elements. Once the openings in the perforate band regions are aligned with the outer rims, the sleeve may be sealed to the fluid treatment elements, for example, by bonding or heat shrinking.

The fluid treatment arrangement 10 may then be installed in the housing 46 in a manner similar to that previously described with respect to the fluid treatment arrangement 10 shown in FIG. 7, forming the fluid treatment assembly 45 shown in FIG. 8.

In one mode of operation, a feed fluid may be directed from the interior of the core assembly to the exterior of the fluid treatment arrangement. The fluid may pass from the interior 22 of the core assembly 11 through the openings 21 into the spaces 20 between the fluid treatment elements 12. From the spaces 20, the fluid may pass generally axially edgewise into the windings of the side edges 30, 31; 30a, 31a of the ribbon 23 including the permeable fluid treatment medium 32 comprising end surfaces 13, 14 of each fluid treatment element 12. The fluid may also flow generally radially through the openings 21 in the core assembly 11 into the inner rim 15 of each fluid treatment element 12. The fluid may then pass generally radially outwardly within each fluid treatment element 12 through successive windings of the ribbon 23 including the permeable fluid treatment medium 32 to the outer rim 16. As the fluid flows within each fluid treatment element, the fluid is treated in accordance with the one or more fluid treatment characteristics of the fluid treatment medium 32. Treated fluid exits each fluid treatment element 12 via the outer rims 16 and passes to the exterior of the fluid treatment arrangement 10 through the openings 60 in the surround 55.

In the embodiment illustrated in FIG. 8, the feed fluid may enter the housing 46 through the feed inlet port 52 and follow the fluid flow path 54 to the permeate outlet port 53. From the feed inlet port 52, the feed fluid may flow generally axially along the interior 22 of the core assembly 11. The feed fluid then flows generally radially outwardly through the openings 21 in the core assembly 11 into the feed spaces 20 between the end surfaces 13, 14 of the fluid treatment elements 12. From the feed spaces 20, the feed fluid may enter the fluid treatment elements 12 by flowing generally axially into the end surfaces 13, 14 of the fluid treatment elements 12, for example, via the side edges 30, 31; 30a, 31a of the ribbon 23 including the permeable fluid treatment medium 32. The feed fluid may also enter the fluid treatment elements 12 by flowing generally radially outwardly through the openings 21 in the core assembly 11 into the inner rims 15. Inside each fluid treatment element 12 the fluid may pass along the fluid flow path 54 via the fluid pathway 44 to the outer rim 16. For windings closer to the outer rim 16, the fluid may flow generally axially edgewise through the ribbon 23 including the fluid treatment medium 32 toward the outer rim 16. For windings farther from the outer rim 16, the fluid may flow generally radially outwardly normal to the major surfaces 25, 26; 25a, 26a of the ribbon 23 including the permeable fluid treatment medium 32 through successive windings toward the outer rim 16. As the fluid flows within the fluid treatment elements 12, the fluid may be treated in any of numerous ways, depending on the fluid treatment characteristics of the fluid treatment media. The treated fluid exits the fluid treatment elements 12 via the outer rims 16, passes through the openings 60 in the surround 55, and flows generally axially along the housing 46 between the exterior of the fluid treatment elements 12 and the interior of the shell 51 to and through the permeate outlet port 53 of the housing 46.

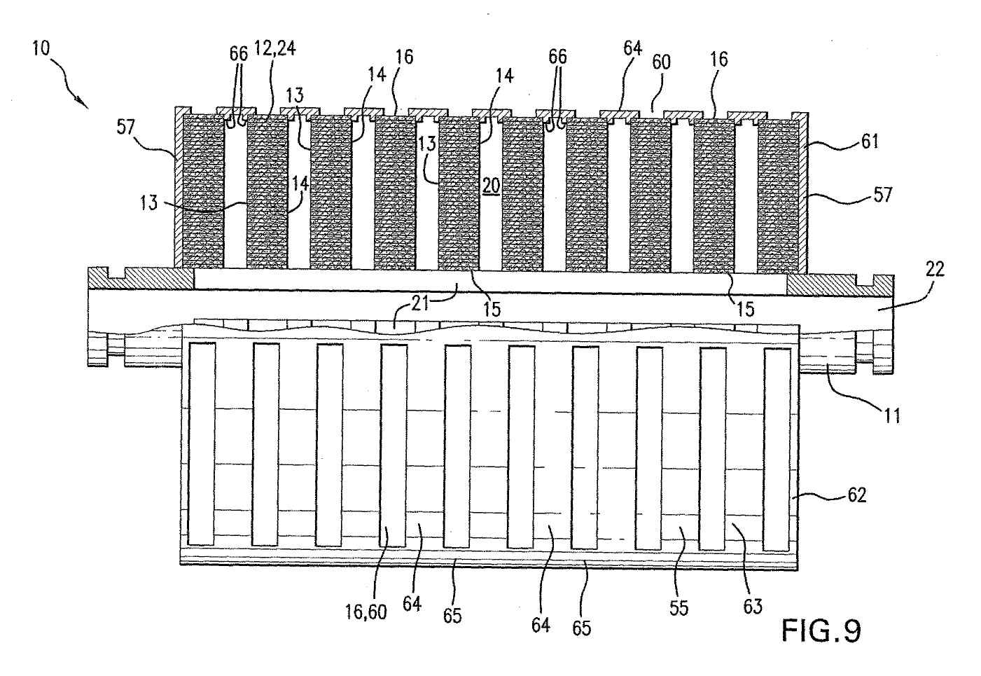

While various aspects of the invention have been previously described and/or illustrated with respect to several embodiments, the invention is not limited to these embodiments. For instance, one or more features of these embodiments may be eliminated or modified, or one or more features of any embodiment may be combined with one or more features of other embodiments, without departing from the scope of the invention. For example, the surround may comprise a more rigid structure to provide additional support at the outer rims of the fluid treatment elements. In one embodiment, the surround 55 may comprise semi-cylindrical sections 61, 62 which may be joined to form a more rigid cage 63, as shown in FIG. 9. The fluid treatment elements 12 and the core assembly 11 shown in FIG. 9 may be identical to those previously described with respect to FIG. 8, but neither the surround, the fluid treatment elements, nor the core assembly are limited to the features shown in FIGS. 8 and 9. The semi-cylindrical sections 61, 62 of the surround 55 may be fitted around the outer rims 16 of the fluid treatment elements 12 and permanently or removably joined to one another to form the cage 63. The cage 63 may comprise a plurality of axially separated impermeable band regions 64 alternating with a plurality of axially separated perforate band regions 65 having a plurality of circumferentially spaced openings 60. The cage 63 may be sealed around the fluid treatment elements 12 with the impermeable band regions 64 fluidly blocking the outer ends of the spaces 20. The perforate band regions 65 may overlie the outer rims 16 of the fluid treatment elements 12, and the outer rims 16 may cover each of the circumferentially spaced openings 60 in the perforate band regions 65.

The outer rims 16 of the fluid treatment elements 12 may be sealed against the cage 63 in a variety of ways. For example, the outer rims 16 may be adhesively bonded or heat bonded to the cage 63 without blinding the outer rims 16 at the openings 56. Alternatively or additionally, the outer rims 16 may be sealed against the cage 63 by a tight mechanical fit. For example, a pair of circumferential ribs 66 may extend radially inwardly a short distance from the interior of each semi-cylindrical section 61, 62 and may be spaced apart a distance equal to or slightly less than the width of the outer rim 16 of each fluid treatment element 12. The sections 61, 62 may be fitted around the fluid treatment arrangement 10 with each outer rim 35 tightly fitting between a corresponding pair of ribs 66.

The cage 63 illustrated in FIG. 9 may also be combined with the fluid treatment arrangement 10 shown in FIG. 1 to provide additional support at the outer rims 16 of the fluid treatment elements 12. The cage 63 may be sealed around the fluid treatment arrangement 10 shown in FIG. 1 with the impermeable band regions 64 overlying the outer rims 16 of the fluid treatment elements 12 and the perforate band regions 65 overlying the spaces 20. The spaces 20 may then fluidly communicate with the exterior of the fluid treatment arrangement 10 via the openings 60 in the perforate band regions 65, e.g., to receive fluid from the exterior of the fluid treatment arrangement 10. The impermeable band regions may also be perforated, allowing the outer rims to receive fluid from the exterior of the fluid treatment arrangement 12.

As yet another example, fluid treatment elements may be positioned along the core assembly by sliding preformed elements generally axially along the core assembly. For example, each ribbon may be spirally wound in a plurality of windings to a desired radial dimension around a central hub, rather than around the core assembly, to form a fluid treatment element. The preformed fluid treatment elements may then be slid axially, with or without the hub, along the core assembly to the desired locations and fixed in place.

Further, embodiments having different features may nonetheless be within the scope of the invention. For example, each ribbon may be spirally wound around a hub to form a fluid treatment element. Each hub may comprise a section of the core assembly, and the hub sections of adjacent elements may be connected to one another to form the hollow core assembly and the fluid treatment arrangement. The hub sections may be mechanically coupled to one another and/or bonded to one another. Some of the hub sections may include openings which are covered by the inner end region of the ribbon and allow fluid communication from the inner rims of the fluid treatment elements to the interior of the core assembly. Other hub sections may include openings which allow fluid communication from the interior of the core assembly to the end surfaces of the fluid treatment elements.

As another example, a sheet assembly may comprise a sheet of the porous fluid treatment medium as the sole component or as one layer of a multilayer composite, e.g., similar to the multilayer composite of the ribbon. The sheet assembly may be spirally wound in a plurality of windings to form a roll having a desired radial dimension. Sections having a desired width may then be cut, e.g., sliced, from the roll in a direction perpendicular to the axis of the roll to form the fluid treatment elements. The fluid treatment elements may then be positioned along a core assembly, e.g., by axially sliding the preformed elements along the core assembly, or the fluid treatment elements may be positioned on hub sections and the hub sections may be connected to one another to form fluid treatment arrangement including the hollow core assembly.

As yet another example, a fluid treatment arrangement may include multiple sets, e.g., two, three, four or more sets, of fluid treatment elements which are mounted along a core assembly radially displaced from one another, for example, in a manner similar to that disclosed in U.S. Provisional Application No. 60/907,066 entitled Fluid Treatment Arrangements with Sets of Fluid Treatment Elements and Methods for Making and Using Them, which listed Thomas Welch Jr., Tanweer ul Haq, and Joseph Verschneider as an inventor and which was filed on Mar. 19, 2007, and the PCT International application which claims priority based on this Provisional application, both of which are incorporated by reference to support these and other features. Each set may include a plurality of fluid treatment elements, each element including a ribbon which is spirally wound in a plurality of windings to form a generally disk-shaped body having a radial dimension. The outer set of fluid treatment elements may be radially displaced outwardly from the inner set of fluid treatment elements with the elements of the inner and outer sets radially and/or axially aligned or offset. For example, the elements of the outer set may bridge at least some of the spaces between the elements of the inner set. Further, the size, e.g., the width and radial dimension, and/or the fluid treatment characteristics of the outer set of fluid treatment elements may be the same as or different from those of the inner set of fluid treatment elements.

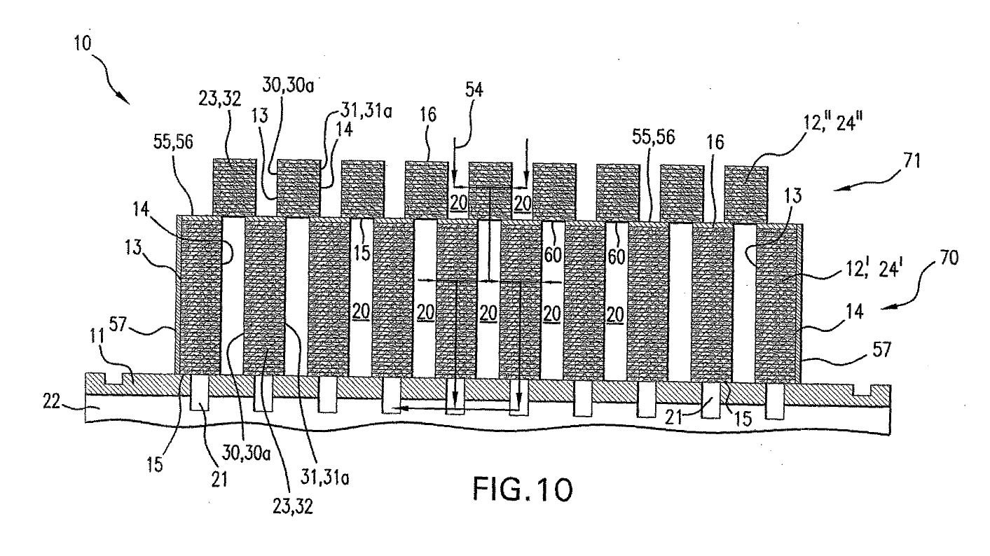

In the embodiment shown in FIG. 10, a fluid treatment arrangement 10 may include at least inner and outer sets 70, 71 of fluid treatment elements 12′,12″ having disk-shaped bodies 24′,24″ mounted along a core assembly 11. The inner set 60 of fluid treatment elements 12′ may be positioned along and immediately circumjacent to the core assembly 11 with inner spaces 20 between the adjacent inner fluid treatment elements 12. For example, the inner set 70 of fluid treatment elements 12′ and the core assembly 11 may be similar to those shown in FIG. 1. The inner fluid treatment elements 12′ may be mounted along the core assembly 11 with the inner rims 15 of the inner fluid treatment elements 12′ covering axially separated openings 21 in the core assembly 11 in any of the ways previously described. The outwardly facing end surfaces 13, 14 of both endmost inner fluid treatment element 12′ may be sealed by a seal 57 as previously explained to prevent bypass of fluid around the outer fluid treatment elements 12″.

The fluid treatment arrangement 10 may further include a surround 55 positioned between the inner and outer sets 70, 71 of fluid treatment elements 12′,12″. The surround may be similar to any of the surrounds previously described. In the embodiment shown in FIG. 10, the surround 55 may include a plurality of axially separated impermeable bands 56 sealed against the outer rims 16 of the inner fluid treatment elements 12. The bands 56 may comprise a strip of polymeric material or a layer of solidified settable bonding material bonded to the outer rims 16. The plurality of axially separated bands 56 define a plurality of axially separated openings 60 between the bands 56.

Radially displaced outwardly from the inner set 70 of fluid treatment elements 12′, the outer set 71 of fluid treatment elements 12″ may also be mounted along the core assembly 11 with outer spaces 20 between adjacent fluid treatment elements 12″. The outer spaces 20 between the outer fluid treatment elements 12″, as well as the inner spaces 20 between the inner fluid treatment elements 12′, may be substantially free of structure or may include various structures as previously described. The fluid treatment elements 12″ of the outer set 71 may be similar to the fluid treatment elements 12′ of the inner set 70. Each outer fluid treatment element 12″ may also comprise a ribbon 23 which includes a permeable fluid treatment medium 32 and is spirally wound in a plurality of windings to define a generally disk-shaped body 24. The disk-shaped body 24 may include an end surface 13 facing in one axial direction, another end surface 14 facing in the opposite axial direction, another end surface 14 facing in the opposite axial direction, an inner rim 15, and an outer rim 16. One end surface 13 may comprise a plurality of windings of one side edge 30, 30a of the ribbon 23 and the permeable fluid treatment medium 32, and the opposite end surface 14 may comprise a plurality of windings of the opposite side edge 31, 31a of the ribbon 23 and the permeable fluid treatment medium 32. The size of each outer fluid treatment element 12″ may be the same as or different from the size of each inner fluid treatment element 12″, and the outer fluid treatment elements 12″ may have a fluid treatment characteristic which is the same as or different from the fluid treatment characteristic of the inner fluid treatment elements 12′. The outer fluid treatment elements 12″ may be positioned along the exterior of the inner fluid treatment elements 12′ and the surround 55 with the inner rims 15 covering the openings 56 in the surround 55. For example, the outer fluid treatment elements 12″ may be mounted along and sealed to the surround 55 in many of the same ways that the fluid treatment elements 12 of the embodiment shown in FIG. 1 may be mounted along and sealed to the core assembly 11.

In one mode of operation, fluid may be directed through the fluid treatment arrangement 10 along a fluid flow path 54 from the exterior of the fluid treatment arrangement 10 to the interior 22 of the core assembly 11. For example, in the embodiment shown in FIG. 10, feed fluid may be directed generally radially inwardly into the outer spaces 20, feed fluid flow into the outer rims 16 of the inner fluid treatment elements 12′ being blocked by the surround 55, e.g., the impermeable bands 56. From the outer spaces 20 the feed fluid may flow axially into the facing end surfaces 13, 14 of each pair of adjacent outer fluid treatment elements 12″. For example, feed fluid may be directed into the outer fluid treatment elements 12″ generally edgewise into the side edges 30, 30a; 31, 31a of each ribbon 23 including each permeable fluid treatment medium 32. Feed fluid may also enter the outer fluid treatment elements 12″ radially through the outer rims 16. Within the outer fluid treatment elements 12″ the fluid may flow generally radially inwardly through successive windings to the inner rims 15, and the fluid may be treated in accordance with the fluid treatment characteristic of the fluid treatment media 32 of the outer fluid treatment elements 12″. The treated fluid exits the outer fluid treatment elements 12″ via the inner rims 15 and passes generally radially inwardly through the openings 60 in the surround 55 into the inner spaces 20 between the inner fluid treatment elements 12′.

In the inner spaces 20 further radially inward flow is blocked by the solid wall portions of the core assembly 11, and the fluid flows axially into the facing end surfaces 13, 14 of each pair of adjacent inner fluid treatment elements 12′. For example, fluid may be directed into the inner fluid treatment elements 12′ generally edgewise into the side edges 30, 30a; 31, 31a of the ribbon 23 including the permeable fluid treatment medium 32. Within the inner fluid treatment elements 12′ the fluid may flow generally radially inwardly through successive windings to the inner rim 15, and the fluid may be treated in accordance with the fluid treatment characteristic of the fluid treatment media 32 of the inner fluid treatment elements 12′. The treated fluid exits the inner fluid treatment elements 12′ via the inner rims 15 and passes generally radially inwardly through the openings 21 in the core assembly 11 into the interior 22 of the core assembly 11.

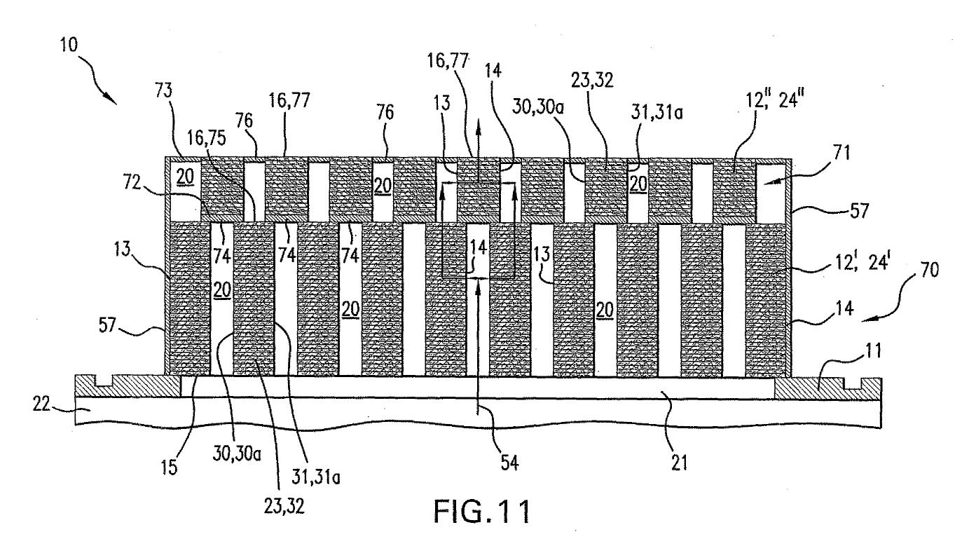

Fluid treatment arrangements having multiple radially displaced sets of fluid treatment elements may be differently embodied for fluid flow from the interior of the core assembly to the exterior of the fluid treatment arrangement. For example, in the embodiment shown in FIG. 11, the fluid treatment arrangement 10 may include inner and outer sets 70, 71 of fluid treatment elements 12′,12″ having disk-shaped bodies 24′,24″ mounted along a core assembly 11 with an inner surround 72 positioned between the inner and outer sets 70, 71 of elements 12′,12″ and an outer surround 73 positioned around the outer set 71 of elements 12′. The core assembly 11, the fluid treatment elements 12′ of the inner set 70, and the inner surround 72 may be substantially identical to the core assembly 11, the fluid treatment elements 12 and the surround 55 of the embodiment illustrated in FIG. 8 and may be mounted to one another in any of the ways previously described. The inner fluid treatment elements 12′ may be mounted along the core assembly 11 with an inner space 20 between each pair of adjacent elements 12′. The long narrow openings 21 in the core assembly 11 may fluidly communicate with the inner spaces 20 and the inner rims 15 of the inner fluid treatment elements 12′. The inner surround 72 may include axially separated inner bands 74 and axially separated inner openings 75 which are similar to the bands 56 and openings 60 of the embodiment shown in FIG. 8. The inner bands 74 may encircle the outer ends of the inner spaces 20, fluidly isolating the inner spaces 20 from the exterior of the inner fluid treatment elements 12′. The inner bands 74 may be sealed to the inner fluid treatment elements 12′ with the outer rims 16 covering the openings 75 in the inner surround 72. The outwardly facing end surfaces 13, 14 of both endmost inner fluid treatment elements 12′ may be sealed by a seal 57 as previously described to prevent bypass of fluid around the outer fluid treatment elements 12″. The seal 57 may extend to the outer surround 73.

The fluid treatment elements 12″ of the outer set 71 may be substantially identical to the outer fluid treatment elements 12″ of the embodiment shown in FIG. 10. The outer set 71 of fluid treatment elements 12″ is radially outwardly from the inner set 71 and may be mounted along the core assembly 11 with outer spaces 20 between each pair of adjacent outer fluid treatment elements 12″. The outer fluid treatment elements 12″ may be positioned along the exterior of the inner fluid treatment elements 12′ and the inner surround 72, for example, with the inner rims 15 of the outer elements 12″ facing the inner bands 74 and the outer rims 16 of the inner elements 12′ fluidly communicating with the outer spaces 20 through the openings 75 in the inner surround 72.

The outer surround 71 may be similar to the inner surround 70 and may include axially separated outer bands 76 and axially separated outer openings 77. The outer bands 76 may encircle the outer ends of the outer spaces 20, fluidly isolating the outer spaces 20 from the exterior of the outer fluid treatment elements 12″. The outer bands 76 may be sealed to the outer fluid treatment elements 12″ with the outer rims 16 covering the openings 77 in the outer surround 73.

In one mode of operation, fluid may be directed through the fluid treatment arrangement 10 along a fluid flow path 54 from the interior 22 of the core assembly 11 to the exterior of the fluid treatment arrangement 10. For example, in the embodiment shown in FIG. 11, feed fluid may be directed generally radially outwardly from the interior 22 through the openings 21 in the core assembly 11 into the inner spaces 20, feed fluid flow into the inner rims 15 of the outer fluid treatment elements 12″ being blocked by the inner surround 72, e.g., the inner bands 74. From the inner spaces 20 feed fluid may flow axially into the facing end surfaces 13, 14 of each pair of adjacent inner fluid treatment elements 12′, flowing generally edgewise into the side edges 30, 30a; 31, 31a of each ribbon 23 including each permeable fluid treatment medium 32. Feed fluid may also enter the inner fluid treatment elements 12″ radially through the inner rims 16. Within the inner fluid treatment elements 12′ the fluid may flow generally radially outwardly through successive windings to the outer rims 16, and the fluid may be treated in accordance with the fluid treatment characteristic of the fluid treatment media 32 of the inner fluid treatment elements 12′. The treated fluid exits the inner fluid treatment elements 12′ via the outer rims 16 and passes generally radially outwardly through the openings 75 in the inner surround 72 into the outer spaces 20 between the outer fluid treatment elements 12″.

In the outer spaces 20 further radially outward flow is blocked by the outer surround 73, e.g., the outer bands 76. The fluid thus flows generally axially into the facing end surfaces 13, 14 of each pair of adjacent outer fluid treatment elements 12″, e.g., flowing generally edgewise into the side edges 30, 30a; 31, 31a of each ribbon 23 including each permeable fluid treatment medium 32. Within the outer fluid treatment elements 12″ the fluid may flow generally radially outwardly through successive windings to the outer rim 16, and the fluid may be treated in accordance with the fluid treatment characteristic of the fluid treatment media 32 of the outer elements 12″. The treated fluid exits the outer fluid treatment elements 12″ via the outer rims 16, passing generally radially outwardly through the openings 77 in the outer surround 73 to the exterior of the fluid treatment arrangement 10.

Fluid treatment arrangements having multiple, radially displaced sets of fluid treatment elements may be contained within a wide variety of housings to provide fluid treatment assemblies, as previously described with respect to the embodiments of FIGS. 7 and 8.

As another example, spirally wound disk-shaped fluid treatment elements which have a fluid pathway that extends into the end surfaces and out of a rim, i.e., radial flow fluid treatment elements, may be supplemented by fluid treatment elements which have a fluid pathway that extends into one end surface and out of the opposite end surface, i.e., axial flow fluid treatment elements. For instance, one or more of the radial flow fluid treatment elements 12, 12′,12″ of any of the previously disclosed embodiments may be supplemented by one or more axial flow fluid treatment elements positioned next to one or both end surfaces 13, 14 of the radial flow elements 12, 12′,12″.

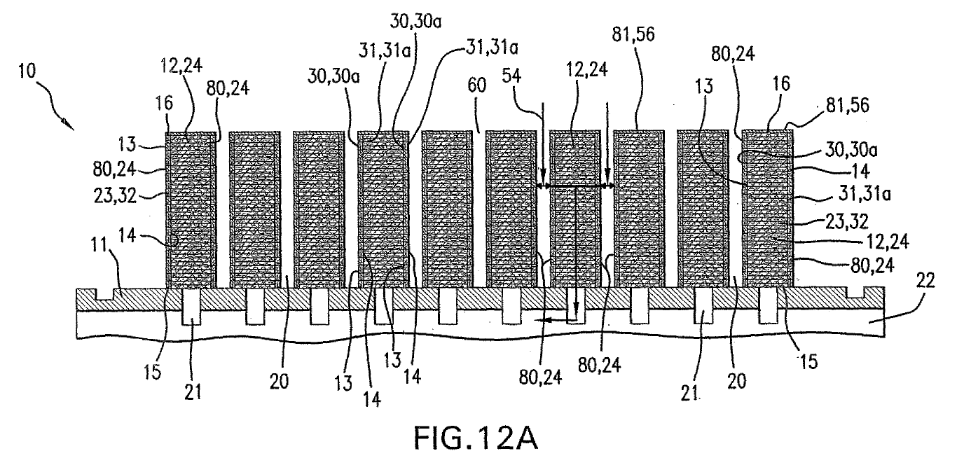

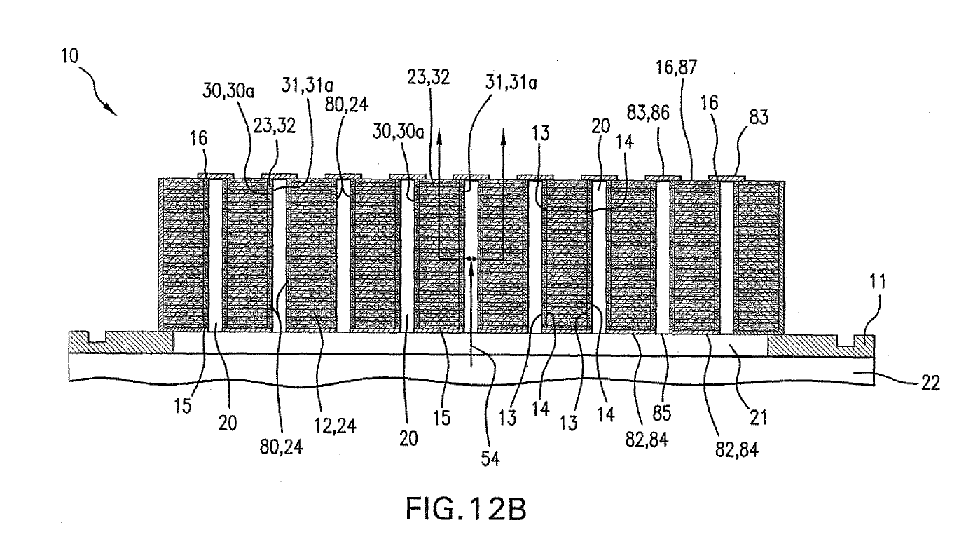

For example, the fluid treatment arrangement 10 shown in FIG. 12A may be very similar to the fluid treatment arrangement 10 shown in FIG. 1. The core assembly 11 and the spirally wound, radial flow fluid treatment elements 12 and disk-shaped bodies 24 which cover the openings 21 in the core assembly 11 may be substantially identical in both embodiments. However, the fluid treatment arrangement 10 shown in FIG. 12A may further include supplemental axial flow fluid treatment elements 80 along both end surfaces 13, 14 of each radial flow fluid treatment element 12. Each axial flow fluid treatment element 80 may be a spirally wound disk-shaped fluid treatment element and may include a ribbon 23 having a permeable fluid treatment medium 32. The ribbon 23 including the permeable fluid treatment medium 32 may be spirally wound in a plurality of windings to form a disk-shaped body 24 having an end surface 13 that faces in one axial direction, an end surface 14 that faces in the opposite axial direction, an inner rim 15, and an outer rim 16. One end surface 13 comprises a plurality of windings of one side edge 30, 30a of the ribbon 23 and the fluid treatment medium 32. The other end surface 14 comprises a plurality of windings of the opposite side edge 31, 31a of the ribbon 23 and the fluid treatment medium 32. Either or both end surfaces 13, 14 may be an even or uneven surface as previously described. The radial dimension of each axial flow fluid treatment element 80 may be substantially equal to the radial dimension of each radial flow fluid treatment element 12. However, the volumes of the fluid treatment elements 12, 80 may be the same or different, and the fluid treatment characteristics of the fluid treatment media of the fluid treatment elements 12, 80 may be the same or different.

The axial flow fluid treatment elements 80 may be formed and mounted along the core assembly 11 in any manner previously described with respect to the radial flow fluid treatment elements 12. However, each axial flow fluid treatment element 80 may be mounted to a solid wall portion of the core assembly 11 which has no openings with the inner rim 15 of the axial flow fluid treatment element 80 sealed to the solid wall portion of the core assembly 11. In the fluid treatment arrangement 10 shown in FIG. 12A, a solid wall portion of the core assembly 11 may be adjacent to the core opening 21 on each side of the opening 21. For each radial flow fluid treatment element 12, an axial flow fluid treatment element 80 may be mounted in one space 20 to the solid wall portion on one side of the core opening 21. An end surface 14 of the axial flow fluid treatment element 80 may be spaced from or in close proximity to, e.g., in contact with, one end surface 13 of the radial flow fluid treatment element 12. Another axial flow fluid treatment element 80 may be mounted in another space 20 to the solid wall portion on the other side of the core opening 21. An end surface 13 of the other axial flow fluid treatment element 80 may be spaced from or in close proximity to, e.g., in contact with, the opposite end surface 14 of the radial flow fluid treatment element 12. Thus, in each space 20 two axial flow fluid treatment elements 80 may be located spaced from one another. The axial flow fluid treatment elements 80 on both sides of the radial flow fluid treatment element 12 may have the same or different fluid treatment characteristics.

The fluid treatment arrangement 10 shown in FIG. 12A may further include a surround 81 that may have any of the previously described configurations. For example, the surround 81 may comprise a plurality of axially separated impermeable bands 56 and a plurality of axially separated openings 60. Each band 56 may extend completely across and seal the outer rim 16 of a radial flow fluid treatment element 12 and the outer ends of the interfaces between the axial flow fluid treatment elements 80 and the radial flow fluid treatment elements 12 to prevent bypass of the axial flow fluid treatment elements 80. The band 56 may also extend completely across and seal the outer rims 16 of the axial flow fluid treatment elements 80. The openings 60 in the surround 81 fluidly communicate with the spaces 20 between the axial flow fluid treatment elements 80.

In one mode of operation, fluid may be directed from the exterior of the fluid treatment arrangement 10 generally axially through each axial flow fluid treatment element 80 and generally radially through each radial flow fluid treatment element 12 to the interior 22 of the core assembly 11. For example, in the fluid treatment arrangement 10 shown in FIG. 12A, feed fluid may flow along a flowpath 54 generally radially inwardly through the openings 60 in the surround 81 into the spaces 20, further radial flow being blocked by the solid wall portions of the core assembly 11. From the spaces 20 the feed fluid may flow generally axially into the facing end surfaces 13, 14 of the adjacent axial flow fluid treatment elements 80, pass generally axially through the fluid treatment elements 80, and exit the opposite end surfaces 14, 13. For example, the feed fluid may enter the plurality of windings of one side edge 30, 30a; 31, 31a of the ribbon 23, including the fluid treatment medium 32, of an axial flow fluid treatment element 80, pass generally edgewise through the ribbon 23, and exit the plurality of windings of the opposite side edge 31, 31a; 30, 30a of the ribbon 23. As the fluid passes through each axial flow fluid treatment element 80, the fluid may also flow from the permeable fluid treatment medium 32 of one winding into and laterally along the permeable fluid treatment medium 32 of one or more adjacent or nearby windings. Within each axial flow fluid treatment element 80, the fluid may be treated in accordance with the fluid treatment characteristic of the fluid treatment medium 32. Treated fluid exits the end surfaces 13, 14 of the axial flow fluid treatment elements 80 adjacent to each radial flow fluid treatment element 12 and passes generally axially into the end surfaces 14, 13 of the radial flow fluid treatment element 12. For example, the fluid may flow from the axial flow fluid treatment elements 80 into the side edges 30, 30a; 31, 31a of the ribbon 23, including the fluid treatment medium 32, of each radial flow fluid treatment element 12. Fluid flow may then proceed generally radially inwardly through the radial flow fluid treatment elements 12 to the interior of the core assembly 11 as previously described with respect to the embodiment shown in FIG. 1, the fluid being further treated in accordance with the fluid treatment characteristic of the fluid treatment medium 32 in the radial flow fluid treatment elements 12.

As a further example, the fluid treatment arrangement 10 shown in FIG. 12B may be very similar to the fluid treatment arrangement 10 shown in FIG. 8. The core assembly 11 and the spirally wound, radial flow fluid treatment elements 12 and disk-shaped bodies 24 may be substantially identical in both embodiments. The fluid treatment arrangement 10 may further include supplemental spirally-wound, axial flow fluid treatment elements 80 having disk-shaped bodies 24 which may be substantially identical to the axial flow fluid treatment elements 80 described with respect to FIG. 12A.

The fluid treatment arrangement 10 shown in FIG. 12B may further include an inner surround 82 and an outer surround 83, and either surround may have any of the configurations previously described. For example, the inner surround 82 may be positioned between the core assembly 11 and the fluid treatment elements 12, 80 and may include a plurality of axially separated impermeable inner bands 84 and a plurality of axially separated openings 85 between the inner bands 84. Each inner band 84 may extend completely across and seal an inner rim 15 of each radial flow fluid treatment element 12 and the interfaces between the axial flow fluid treatment elements 80 and the radial flow fluid treatment element 12 to prevent by pass of the axial flow fluid treatment elements 80. The band 84 may also extend completely across and seal the inner rims 15 of the axial flow fluid treatment elements 80. The openings 85 in the inner surround 82 fluidly communicate with the spaces 20 between the fluid treatment elements 12, 80. The outer surround 83 may also comprise a plurality of axially separated impermeable outer bands 86 and a plurality of axially separated openings 87 between the outer bands 86. Each outer band 86 may extend completely across and seal the outer end of a space 20, the outer rims 16 of the axial flow fluid treatment elements 80 in the space 20, and the interfaces between the axial flow fluid treatment elements 80 and the adjacent radial flow fluid treatment elements 12. The openings 87 in the outer surround 83 are covered by the outer rims 16 of the radial flow fluid treatment elements 12.

In one mode of operation, fluid may be directed from the interior 22 of the core assembly 11 generally axially through each axial flow fluid treatment element 80 and generally radially through each radial flow fluid treatment element 12 to the exterior of the fluid treatment arrangement 10. For example, in the fluid treatment arrangement 10 shown in FIG. 12B, feed fluid may flow along a flowpath 54 generally radially outwardly through the openings 21 in the core assembly 11 and the openings 85 in the inner surround 82 into the spaces 20. Further radial flow may be blocked by the outer surround 83, e.g., the outer bands 86. From the spaces 20, fluid flow may proceed axially through the adjacent axial flow fluid treatment elements 80 as previously described with respect to the embodiment of FIG. 12A, the fluid being treated in accordance with the fluid treatment characteristic of the fluid treatment medium 32 in the axial flow fluid treatment elements 80. From the axial flow fluid treatment elements 80, fluid flow then proceeds into the end surfaces 13, 14 of the radial flow fluid treatment elements 12 and generally radially outwardly through the radial flow fluid treatment elements 12 and the outer rims 16 to the exterior of the fluid treatment arrangement 10 as previously described with respect to the embodiment shown in FIG. 8, the fluid being further treated in accordance with the fluid treatment characteristic of the fluid treatment medium 32 in the radial flow fluid treatment elements 12.

Fluid treatment arrangements having radial flow and axial flow fluid treatment elements may be contained in a wide variety of housings to provide fluid treatment assemblies, as previously described with respect to the embodiments of FIGS. 7 and 8.

The present invention is thus not restricted to the particular embodiments which have been described and/or illustrated herein but includes all embodiments and modifications that may fall within the scope of the claims.

1. A fluid treatment arrangement comprising:
a hollow core assembly including an axis, an exterior, an interior, and an opening fluidly communicating between the exterior and the interior of the core assembly;
a fluid treatment element mounted along the core assembly, wherein the fluid treatment element includes a ribbon which has a permeable fluid treatment medium and is spirally wound in a plurality of windings to define a generally disk-shaped body having a radial dimension, a first axially-facing end surface on one side of the body, a second axially-facing end surface on the opposite side of the body, and an inner rim, wherein the inner rim covers the opening in the core assembly; and
a fluid pathway from the first and second end surfaces through one or more windings, the inner rim, and the opening into the interior of the core assembly.

2. The fluid treatment arrangement of claim 1 wherein the inner rim comprises an end region of the ribbon which is wound directly onto the core assembly over the opening.

3. The fluid treatment arrangement of claim 1 wherein the fluid treatment element has an aspect ratio of about 10 or less.

4. (canceled)

5. The fluid treatment arrangement of claim 1 wherein the inner rim has a width and the opening has a width which is less than the width of the inner rim.

6-10. (canceled)

11. The fluid treatment arrangement of claim 1 wherein the fluid treatment element comprises a first fluid treatment element, wherein the fluid treatment arrangement further comprises a second fluid treatment element mounted along the core assembly, the second fluid treatment element including a ribbon having a permeable fluid treatment medium, the ribbon being spirally wound in a plurality of windings to define a generally disk-shaped body having a radial dimension, a first axially-facing end surface on one side of the body, a second axially-facing end surface on the opposite side of the body, and an inner rim, and wherein the second axially-facing end surface of the second fluid treatment element is in close proximity to the first axially-facing end surface of the first fluid treatment element and the inner rim of the second fluid treatment element is sealed by the core assembly.

12. The fluid treatment arrangement of claim 1 wherein the fluid treatment element comprises a first fluid treatment element and the fluid treatment arrangement further comprises second and third fluid treatment elements, wherein each of the second and third fluid treatment elements includes a ribbon which has a permeable fluid treatment medium and is spirally wound in a plurality of windings to define a generally disk-shaped body having a radial dimension, a first axially-facing end surface on one side of the body, a second axially-facing end surface on the opposite side of the body, and an inner rim, wherein the second fluid treatment element is mounted along the core assembly axially separated from the first fluid treatment element to define a first space between the first end surface of the first fluid treatment element and the second end surface of the second fluid treatment element, wherein the third fluid treatment element is mounted along the core assembly axially separated from the first fluid treatment element to define a second space between the second end surface of the first fluid treatment element and the first end surface of the third fluid treatment element, and wherein both of the first and second spaces have an inner end which is isolated from the interior of the core assembly and an outer end which fluidly communicates with the exterior of the fluid treatment elements.

13. The fluid treatment arrangement of claim 12 wherein the opening in the core assembly comprises a first opening and the core assembly further comprises second and third openings axially separated from the first opening, each of the second and third openings fluidly communicating between the exterior and the interior of the core assembly, and wherein the inner rim of the second fluid treatment element covers the second opening and the inner rim of the third fluid treatment element covers the third opening.

14. A fluid treatment assembly comprising a housing and a fluid treatment arrangement of claim 1 disposed in the housing, wherein the housing has first and second ports and defines a fluid flow path between the first and second ports, the fluid treatment arrangement being positioned in the housing across the fluid flow path and the fluid pathway comprising a portion of the fluid flow path.

15. A fluid treatment arrangement comprising:
a hollow core assembly including an axis, an exterior, an interior, and a plurality of openings axially spaced from one another along the core assembly, each opening fluidly communicating between the exterior and the interior of the core assembly, and
a plurality of fluid treatment elements, wherein each fluid treatment element includes a ribbon which has at least one strip of a permeable fluid treatment medium having first and second opposite side edges, wherein the ribbon is spirally wound in a plurality of windings to define a disk-shaped body which includes a first axially-facing end surface comprising a plurality of windings of the first side edge of the permeable fluid treatment medium, a second axially-facing end surface comprising a plurality of windings of the second side edge of the permeable fluid treatment medium, and an inner rim, and wherein the plurality of fluid treatment elements are positioned along the core assembly with spaces between the fluid treatment elements and with the inner rim of each fluid treatment element covering at least one opening in the core assembly.

16. The fluid treatment arrangement of claim 15 wherein the spaces fluidly communicate with the exterior of the fluid treatment elements.

17. (canceled)

18. The fluid treatment arrangement of claim 15 wherein each fluid treatment element has an aspect ratio of about 10 or less.

19-26. (canceled)

27. A fluid treatment assembly comprising a housing and a fluid treatment arrangement of claim 15 disposed in the housing, wherein the housing has first and second ports and defines a fluid flow path between the first and second ports, the fluid treatment arrangement being positioned in the housing across the fluid flow path.

28. A method for making a fluid treatment arrangement comprising:
mounting a plurality of spirally wound disk-shaped fluid treatment elements along a hollow core assembly having a plurality of axially separated openings fluidly communicating between the exterior and the interior of the core assembly, including positioning the fluid treatment elements along the core assembly with an inner rim of each fluid treatment element covering at least one opening in the core assembly.

29. The method of claim 28 wherein mounting the plurality of fluid treatment elements along the core assembly includes sealing the fluid treatment elements to the core assembly to prevent fluid flow into the openings in the core assembly except via the inner rims of the fluid treatment elements.

30. The method of claim 28 wherein mounting each fluid treatment element includes spirally winding a ribbon having a permeable fluid treatment medium in a plurality of openings to form a disk-shaped body having a first end surface on one side of the body, a second end surface on the opposite side of the body, an inner rim, and an outer rim.

31. The method of claim 30 wherein spirally winding the ribbon includes spirally winding the ribbon onto the core assembly over at least one opening in the core assembly.

32-35. (canceled)

36. The method of claim 28 wherein mounting the fluid treatment elements along the core assembly includes providing spaces between them.

37-105. (canceled)

106. A method for treating a fluid comprising:
directing a fluid axially into opposite end surfaces of a spirally wound disk-shaped fluid treatment element and radially out of a rim of the fluid treatment element, including passing the fluid through one or more of a plurality of windings of a ribbon having a permeable fluid treatment medium and treating the fluid by the permeable fluid treatment medium.

107. The method of claim 106 wherein directing a fluid radially out of the rim includes directing the fluid radially out of an inner rim.

108-109. (canceled)

110. The method of claim 107 further comprising passing the fluid from the inner rim directly into the interior of a hollow core assembly.

111-115. (canceled)

116. The method of claim 106 wherein directing fluid into the fluid treatment element comprises directing fluid axially into opposite end surfaces and radially out of a rim of each of a plurality of spirally wound disk-shaped fluid treatment elements.
